(19) United States
(12) Patent Application Publication
(10) Pub. No.: US 2015/0339314 A1
(43) Pub. Date: Nov. 26, 2015

(54) COMPACTION MECHANISM FOR FILE SYSTEM

(71) Applicants: Brian James Collins, New Malden (GB); Stephen Peter Draper, Austin, TX (US)

(72) Inventors: Brian James Collins, New Malden (GB); Stephen Peter Draper, Austin, TX (US)

(21) Appl. No.: 14/287,033

(22) Filed: May 25, 2014

(51) Int. Cl. G06F 17/30

(52) U.S. Cl. CPC G06F 17/30153; G06F 17/30073; G06F 17/30575; G06F 17/30203

(57) ABSTRACT

Increasing data storage efficiency includes receiving an amendment to a set of data objects. The amendment includes new or changed content relative to an earlier version of the set of data objects. The amendment includes one or more data lookup tables. The set of data objects includes data blocks associated with the data lookup tables. The set of data objects is examined to identify data ranges (e.g., byte ranges) that are not referenced in the set of data lookup tables of the amendment. In data ranges that are identified as not referenced in the data lookup tables, the data is replaced with data that is more compressible (for example, the range may be filled with zero values). The set of data objects may be compacted by compressing data including the identified unreferenced data ranges.

### BACKGROUND OF THE INVENTION

1. Field of the Invention

The present invention generally relates to systems and methods for representing data. More particularly, the present invention relates to systems and methods for increasing storage efficiency in data replication systems.

2. Description of the Related Art

Enterprises and organizations often use networks to share data and computer programs among many members. Typically, the data to be shared must be updated from time to time, in some cases frequently. Computer networks often provide an effective solution for sharing updates. Nevertheless, in environments where users are highly remote, such as many military, commercial maritime, and oil and gas operations, high network latency and limited bandwidth may make conventional computer networks ineffective in sharing critical information on a timely basis.

To overcome these challenges, some organizations use data replication systems to share and update data among widely distributed users. These systems, in their most general form, allow one computer to publish changing content as a sequence of amendment files to be transferred to one or more remote client computers in such a way that those clients can see the complete contents published. The size of each amendment file is optimized, containing only new or changed content, in order to minimize the use of communications bandwidth, which may be slow, unreliable, expensive or even only intermittently existent.

In some data replication systems, the size of the shared files on both the publisher and client side progressively grows over time. For example, storage required for a representation may monotonically increase for the entire lifetime of the publication, which may be many years and many thousands of amendments. Data byte sequences used in the data published for any earlier amendment, but no longer in the published content, will remain on all copies of the publication (e.g., all client computers) in perpetuity. Over time, this may result in insufficient storage capacity on client computers and/or publisher computers. In addition, it may require ever increasing processing time to update, exchange, or access the data.

### SUMMARY

Systems and methods of sharing information among computer systems and increasing efficiency in data storage are disclosed. In various embodiments, changes of large unstructured content are transferred from one computer system to other computer systems as a sequence of amendments. Each amendment may include only new or changed content. The content may be accessed at the receiving end of the transfer by methods including, but not limited to, virtualizing based on data lookup tables referencing multiple content data blocks transferred in the separate amendments. Where content transferred in earlier amendments becomes unreferenced by later amendments, storage space required for the unreferenced content is eliminated by: representing content data in a compressible manner, physically storing it in compressed form, and replacing unreferenced content by other content which is more compressible.

In an embodiment, a method for increasing data storage efficiency includes receiving an amendment to a set of data objects. The amendment includes new or changed content relative to an earlier version of the set of data objects. The amendment includes one or more data lookup tables. The set of data objects includes data blocks associated with the one or more data lookup tables. The set of data objects is examined to identify data ranges (e.g., byte ranges) that are not referenced in the set of data lookup tables of the amendment. In data ranges that are identified as not referenced in the data lookup tables, the data is replaced with data that is more compressible (for example, the range may be filled with zero values). The set of data objects is compacted by compressing data including the identified unreferenced data ranges.

In an embodiment, a system includes a processor and a memory coupled to the processor. The memory program instructions are executable by the processor to implement a method that includes receiving an amendment to a set of data objects. The amendment includes new or changed content relative to an earlier version of the set of data objects. The amendment includes one or more data lookup tables. The set of data objects includes data blocks associated with the one or more data lookup tables. The set of data objects is examined to identify data ranges (e.g., byte ranges) that are not referenced in the set of data lookup tables of the amendment. In data ranges that are identified as not referenced in the data lookup tables, the data is replaced with data that is more compressible (for example, the range may be filled with zero values). The set of data objects is compacted by compressing data including the identified unreferenced data ranges.

In an embodiment, a non-transitory, computer-readable storage medium includes program instructions stored thereon. The program instructions implement a method that includes receiving an amendment to a set of data objects. The amendment includes new or changed content relative to an earlier version of the set of data objects. The amendment includes one or more data lookup tables. The set of data objects includes data blocks associated with the one or more data lookup tables. The set of data objects is examined to identify data ranges (e.g., byte ranges) that are not referenced in the set of data lookup tables of the amendment. In data ranges that are identified as not referenced in the data lookup tables, the data is replaced with data that is more compressible (for example, the range may be filled with zero values). The set of data objects is compacted by compressing data including the identified unreferenced data ranges.

In an embodiment, a method for increasing data storage efficiency includes examining a set of data objects. The data objects include data blocks associated with a set of one or more data lookup tables. From the examination, data ranges (e.g., byte ranges) that are not referenced in the set of data lookup tables are identified. In the data ranges that are not referenced in the data lookup tables, data is replaced with data that is more compressible. In an embodiment, a system includes a processor and a memory coupled to the processor. The memory program instructions are executable by the processor to implement a method that includes examining a set of data objects. The data objects include data blocks associated with a set of one or more data lookup tables. From the examination, data ranges (e.g., byte ranges) that are not referenced in the set of data lookup tables are identified. In the data ranges that are not referenced in the data lookup tables, data is replaced with data that is more compressible.

In an embodiment, a non-transitory, computer-readable storage medium includes program instructions stored thereon. The program instructions implement a method that includes examining a set of data objects. The data objects include data blocks associated with a set of one or more data lookup tables. From the examination, data ranges (e.g., byte ranges) that are not referenced in the set of data lookup tables are identified. In the data ranges that are not referenced in the data lookup tables, data is replaced with data that is more compressible.

In an embodiment, a method for increasing data storage efficiency of a replication system includes receiving an update to a file system. The file system includes a set of data objects. Data blocks in the data objects are examined to identify data ranges that are not referenced in the update. Data in the data ranges that have been identified as unreferenced are replaced with data that is more compressible.

In an embodiment, a system includes a processor and a memory coupled to the processor. The memory program instructions are executable by the processor to implement a method that includes receiving an update to a file system. The file system includes a set of data objects. Data blocks in the data objects are examined to identify data ranges that are not referenced in the update. Data in the data ranges that have been identified as unreferenced are replaced with data that is more compressible.

In an embodiment, a non-transitory, computer-readable storage medium includes program instructions stored thereon. The program instructions implement a method that includes receiving an update to a file system. The file system includes a set of data objects. Data blocks in the data objects are examined to identify data ranges that are not referenced in the update. Data in the data ranges that have been identified as unreferenced are replaced with data that is more compressible.

In an embodiment, a method of reducing storage needs for an arbitrary entity includes replacing one or more parts that are deemed irrelevant for a current contextual usage with compressible data, and then storing a modified entity in a compressed format.

### BRIEF DESCRIPTION OF THE DRAWINGS

A better understanding of the present invention may be obtained when the following detailed description is considered in conjunction with the following drawings, in which:

FIG. 1 is a network diagram of a wide area network that is suitable for implementing various embodiments;

FIG. 2 is an illustration of a typical computer system that is suitable for implementing various embodiments;

FIG. 3 is a flowchart of an exemplary process that generates required information about the original file system according to one embodiment;

FIGS. 4, 5, and 6 are flowcharts of an exemplary process that generates the lookup table file and modification data block file for an update to the representation of the original file system generated by the process shown in FIG. 3 according to one embodiment;

FIG. 7 is a flowchart of an exemplary process that generates a delta directory map file for the new version of the original file system from the delta directory entry meta-data table generated by the process shown in FIGS. 4, 5 and 6 according to one embodiment;

FIG. 8 is a flowchart of an exemplary process that uses the files for an update generated by the process shown in FIGS. 4, 5, 6 and 7 to generate a latest version of the original file system according to one embodiment;

FIG. 9 is a flowchart for preparing an update in a first fit data blocks file management scheme according to one embodiment;

FIG. 10 is a flowchart for preparing an update in a least recently used data blocks file management scheme according to one embodiment;

FIG. 11 is a flowchart for updating a client according to one embodiment;

FIG. 12 is a flowchart for managing open files during an update according to one embodiment;

FIG. 13 is a flowchart for using sequence numbers to manage open files during an update according to one embodiment;

FIG. 14 is a flowchart for encrypting an updated data blocks file according to one embodiment; and

FIG. 15 is a flowchart for reorganizing references files according to one embodiment.

FIG. 16 illustrates an example of a structure for represented content.

FIG. 17 illustrates a modification to the structure for an amendment to the represented content.

FIG. 18 illustrates one embodiment of a mechanism for reading a file.

FIG. 19 illustrates one embodiment of increasing data storage efficiency using a compaction mechanism.

FIG. 20 illustrates a method for increasing data storage efficiency that includes replacing data that is unreferenced a data lookup table with more compressible data.

FIG. 21 illustrates one embodiment of increasing storage efficiency in a replication system.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF ILLUSTRATIVE EMBODIMENTS

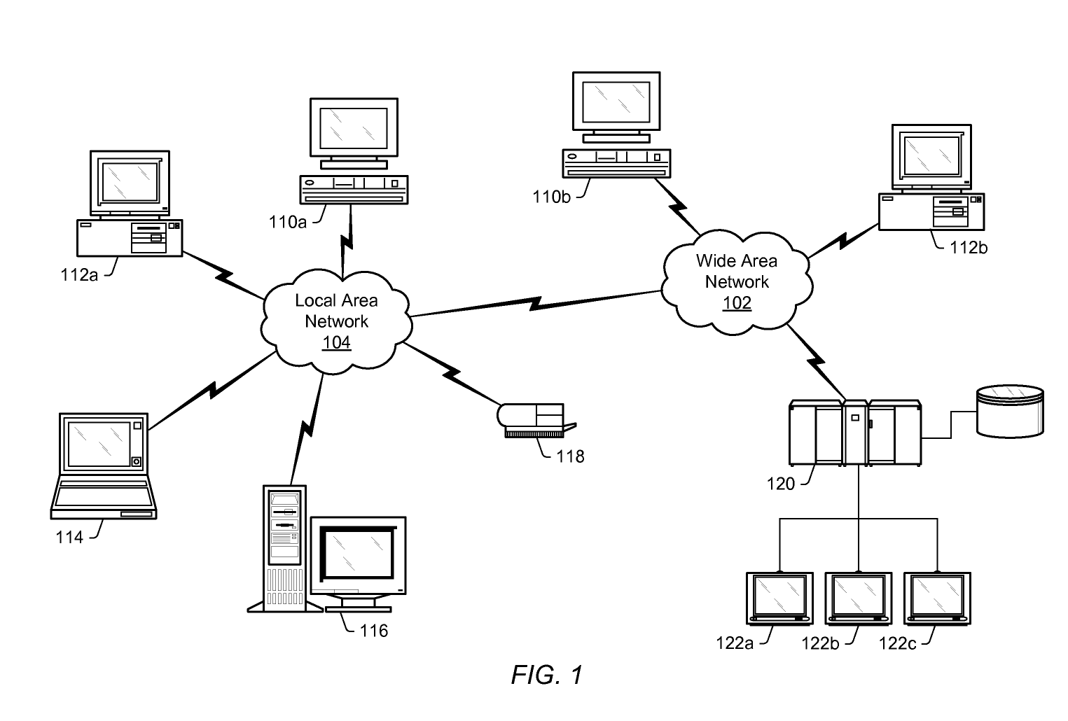

FIG. 1 illustrates a wide area network (WAN) according to one embodiment. A WAN 102 may be a network that spans a relatively large geographical area. The Internet may be an example of a WAN 102. A WAN 102 may include a plurality of computer systems which are interconnected through one or more networks. Although one particular configuration is shown in FIG. 1, the WAN 102 may include a variety of heterogeneous computer systems and networks which are interconnected in a variety of ways and which run a variety of software applications.

One or more local area networks (LANs) 104 may be coupled to the WAN 102. A LAN 104 is a network that spans a relatively small area. Typically, a LAN 104 is confined to a single building or group of buildings. In one embodiment, each node (i.e., individual computer system or device) on a LAN 104 may have its own CPU with which it executes programs, and each node may also be able to access data and devices anywhere on the LAN 104. The LAN 104 may allow many users to share devices (e.g., printers) as well as data stored on file servers. The LAN 104 may be characterized by any of a variety of types of topology (i.e., the geometric arrangement of devices on the network), of protocols (i.e., the rules and encoding specifications for sending data, and whether the network uses a peer-to-peer or client/server architecture), and of media (e.g., twisted-pair wire, coaxial cables, fiber optic cables, radio waves).

Each LAN 104 may include a plurality of interconnected computer systems and optionally one or more other devices: for example, one or more workstations 110a, one or more personal computers 112a, one or more laptop or notebook computer systems 114, one or more server computer systems 116, and one or more network printers 118. As illustrated in FIG. 1, an example LAN 104 may include one of each of computer systems 110a, 112a, 114, and 116, and one printer 118. The LAN 104 may be coupled to other computer systems and/or other devices and/or other LANs 104 through the WAN 102.

One or more mainframe computer systems 120 may be coupled to WAN 102. As shown, mainframe 120 may be coupled to a storage device or file server 124 and mainframe terminals 122a, 122b, and 122c. Mainframe terminals 122a, 122b, and 122c may access data stored in storage device or file server 124 coupled to or included in mainframe computer system 120.

WAN 102 may also include computer systems that are connected to WAN 102 individually and not through a LAN 104: as illustrated, for purposes of example, a workstation 110b and a personal computer 112b. For example, WAN 102 may include computer systems that are geographically remote and connected to each other through the Internet.

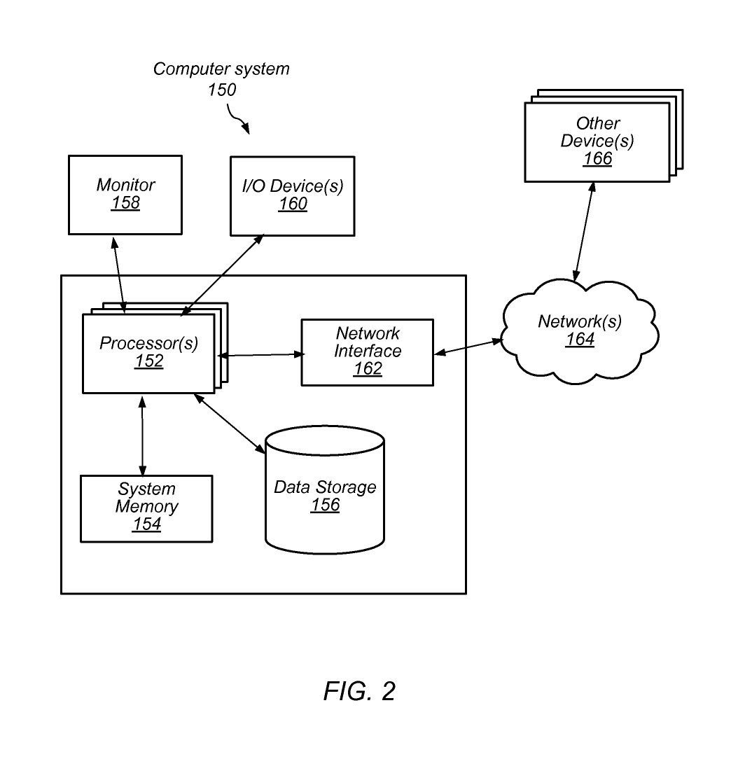

FIG. 2 illustrates a typical computer system 150 that is suitable for implementing various embodiments of a system and method for compaction. Computer system 150 includes one or more processors 152, system memory 154, and data storage device 156. Program instructions may be stored on system memory 154. Processors 152 may access program instructions on system memory 154. Processors 152 may access data storage device 156. Users may be provided with information from computer system 150 by way of monitor 158. Users interact with computer system 150 by way of I/O devices 160. An I/O device 160 may be, for example, a keyboard or a mouse. Computer system 150 may include, or connect with, other devices 166. Elements of computer system 150 may connect with other devices 166 by way of network 164 via network interface 162. Network interface 162 may be, for example, a network interface card. In some embodiments, messages are exchanged between computer system 150 and other devices 166, for example, via a transport protocol, such as internet protocol.

Embodiments of a subset or all (and portions or all) of the above may be implemented by program instructions stored in a memory medium or carrier medium and executed by a processor. A memory medium may include any of various types of memory devices or storage devices. The term “memory medium” is intended to include an installation medium, e.g., a Compact Disc Read Only Memory (CD-ROM), floppy disks, or tape device; a computer system memory or random access memory such as Dynamic Random Access Memory (DRAM), Double Data Rate Random Access Memory (DDR RAM), Static Random Access Memory (SRAM), Extended Data Out Random Access Memory (EDO RAM), Rambus Random Access Memory (RAM), etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer that connects to the first computer over a network, such as the Internet. In the latter instance, the second computer may provide program instructions to the first computer for execution. The term “memory medium” may include two or more memory mediums that may reside in different locations, e.g., in different computers that are connected over a network. In some embodiments, a computer system at a respective participant location may include a memory medium(s) on which one or more computer programs or software components according to one embodiment may be stored. For example, the memory medium may store one or more programs that are executable to perform the methods described herein. The memory medium may also store operating system software, as well as other software for operation of the computer system.

In one embodiment, the memory medium may store a software program or programs for representing modifications to a set of data objects as described herein. The software program(s) may be implemented in any of various ways, including procedure-based techniques, component-based techniques, and/or object-oriented techniques, among others. For example, the software program may be implemented using ActiveX controls, C++ objects, JavaBeans, Microsoft Foundation Classes (MFC), browser-based applications (e.g., Java applets), traditional programs, or other technologies or methodologies, as desired. A CPU, such as the host CPU, executing code and data from the memory medium includes a means for creating and executing the software program or programs according to the methods and/or block diagrams described below.

The hierarchy for the file system may include a directory having a list of file entries and subdirectory entries. The subdirectory entries may include additional files for the file system. Each entry in the directory for the file system hierarchy may also contain meta-data. For the file entries the meta-data may include known file meta-data such as the file name, file attributes, and other known file meta-data.

In various embodiments, generating and updating a file system on a client computer includes making comparisons between an original file system and an updated file system. An original file system may be compared to an updated file system and the differences between the two file systems may be defined in specific data blocks. The differences may include new data blocks, modified data blocks, and data blocks that have been deleted. The new data blocks or modified data blocks may be sent to the client computer along with reference file updates to update the file system on the client computer. A virtual file system on the client computer may be created using the set of data blocks and the reference files to point to which data blocks contain the data for specific files. As the file system is updated, new data blocks and modified data blocks may replace deleted data blocks in the set of data blocks.

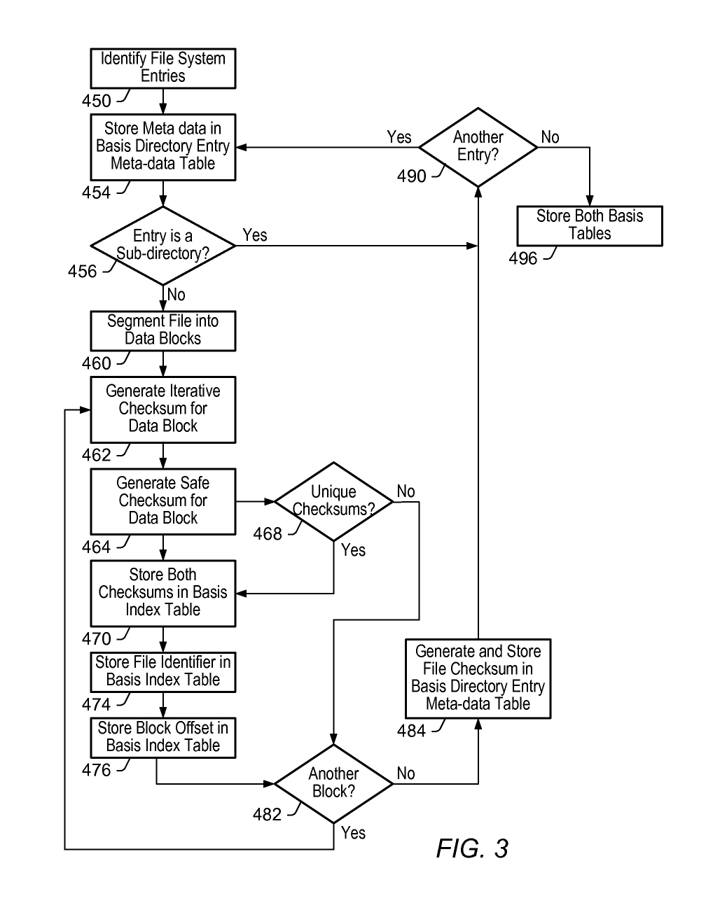

FIG. 3 is a flowchart of an embodiment of a system and method for generating information about the original file system. In order to generate modification data files for a file system hierarchy, the original version of the file system hierarchy may be processed and information about the system is stored in a file system map file.

In 450, file system entries may be identified by processing the directory file for the highest level of the file system hierarchy. These file system entries may include subdirectories and/or files at the highest level in the file system.

In 454, meta-data for each entry may be stored in a basis directory meta-data table. As used herein, a “basis directory meta-data table” generally refers to a basis table including meta-data describing content of a file system hierarchy. As used herein, a “basis table” generally refers to a table including data describing a file system, etc before the file or file system is modified. For example, a basis table may provide a baseline against which future modifications may be compared. Examples of basis tables may include, but are not limited to, an index data block table. In 456, it may be determined if the entry is a subdirectory. If the entry is a subdirectory, in 490, the process may determine whether another entry exists for processing. If another entry exists, processing may loop back to 454. If another entry does not exist, 496 may be reached in which the process terminates. If the entry is not a subdirectory, processing my continue with 460.

In 460, file entries may be segmented into data blocks of one or more fixed lengths (e.g., if the fixed length is 256, there are 256 data units in the data block). In one embodiment, the block length(s) may be chosen so that the entire basis index data block table may be held in the memory of the computer system. An advantage to choosing such a block length is that every block of memory may be directly and efficiently accessed. For this reason, the block length may be determined as a function of the available computer system resources. Additionally, the sub-block-sized remainder at the end of the file may also be treated as a block.

In 462, an iterative checksum may be generated for each data block. Similarly, in 464, a safe checksum may be generated for each data block. The iterative checksum may be a value that is computed from the data values for each byte within a data block beginning at the first byte of the data block and continuing through to the last byte in the data block. It is noted that the iterative checksum for a particular data block which includes the first N data units in a data string may be used to generate the iterative checksum for the next data block comprised of the N data units beginning at the second data byte. This may be done by performing the inverse iterative checksum operation on the iterative checksum using the data content of the first data unit of the first data block to remove its contribution to the iterative checksum and performing the iterative checksum operation on the resulting value using the N+1 data unit that forms the last data unit for the next data block. Thus, two data operations may be used to generate the iterative checksum for the next data block in a data string in which the successive data blocks are formed by using a sliding data window in the data string. For example, an addition operation may be used to generate an iterative checksum having the property noted above.

The size and complexity of a safe checksum may be sufficiently large that the risk of a false match (i.e., producing the same checksum for two data blocks having different data contents) may be less likely to cause a failure than the risk that other components of the complete computer system (e.g., the storage media) may cause a failure (i.e., returning an inaccurate data value).

A safe checksum generation method well known within the data communication art is the MD5 checksum. The iterative and safe checksum pair for a data block form a checksum identifier that may be used to identify the data block. The iterative checksum may not be as computationally complex as the safe checksum so the iterative checksum may be a relatively computational resource efficient method for determining that two data blocks may be the same. The safe checksum may be used to verify that the data content of the blocks are the same and reduce the likelihood of a false positive identification.

In 468, the checksum identifier for the current data block may be compared with the checksum identifiers for data blocks previously stored in the index data block table. If the checksum identifier for the current data block is found to be the same as the checksum identifier for a previously stored data block, the data content of the data block may not be unique, and processing may continue with 482. Thus, the data block record already in the index data block table for the corresponding checksum identifier may adequately define the data block being processed so the checksum identifier is not stored in the index data block table. It is noted that if the checksum identifier for the current data block is found to be different than the checksum identifier for previously stored data blocks (e.g., the checksum identifier is unique), processing may continue with 470, 474, 476, and 482.

In 470, the iterative checksum may be stored as the primary key in the index data block table and the safe checksum may be stored in the index data block table as a qualified key. Associated with the checksum identifier for the block may be an identifier for the file from which the data block came, this identifier may be stored in 474. The offset from the first byte within the file to the first byte in the data block may be stored in 476. In one embodiment, the source file identifier may be the name of the file in which the data block is stored, but it may be a pointer to the meta-data in the basis directory entry meta-data table for the source file.

In 482, it may be determined whether another data block exists for a particular file entry. If another data block does exist, processing may loop back to 462. Otherwise, processing may continue with 484.

In 484, a safe checksum for the entire data content of the file entry may be generated and stored in the basis directory entry meta-data table. In 490, the process may determine whether another entry exists for processing. If another entry exists, processing may loop back to 454. If all entries for the entire directory structure for the original file system have been processed, processing may continue with 496.

In 496, the basis directory entry meta-data table and an basis index data block table file system map file representing the meta-data and data content for each entry within the file system hierarchy may be stored on storage media. In one embodiment, the basis index data block table file system may file may be created by the computer each time the file system is updated. This data may form the baseline for generating modification data files for updating the original file system. In one embodiment, the basis directory entry meta-data table and the basis index data block table may form a representation of the file system and the contents of the file system.

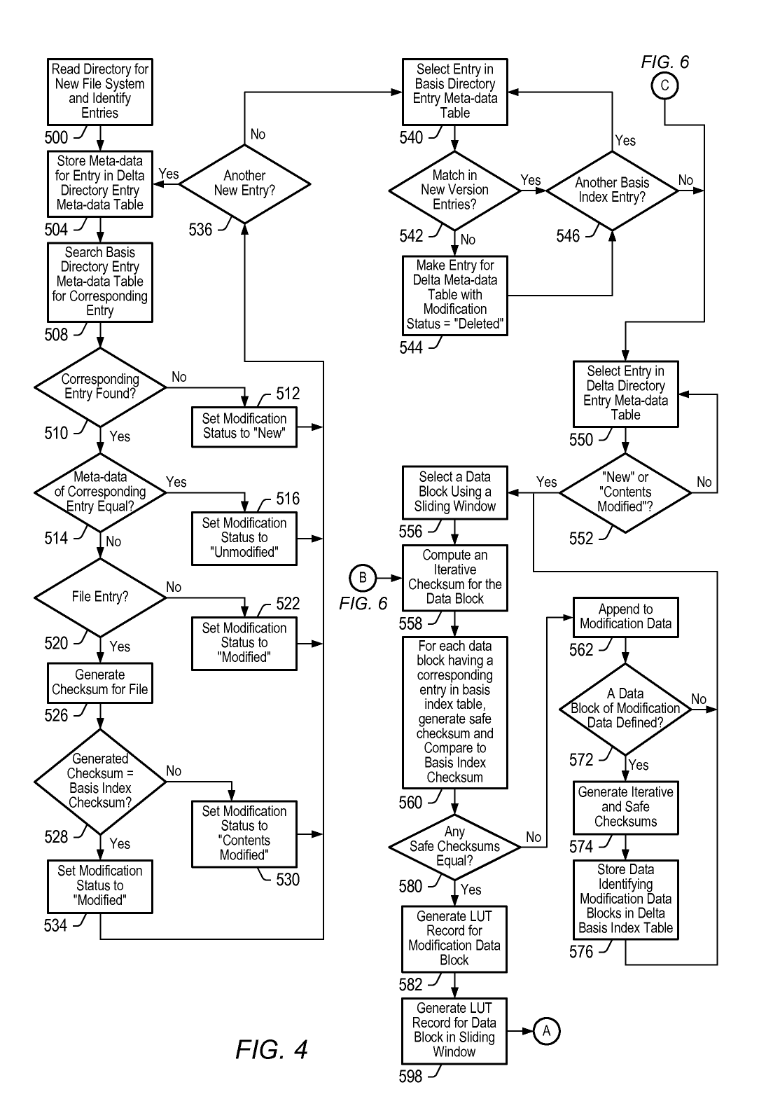

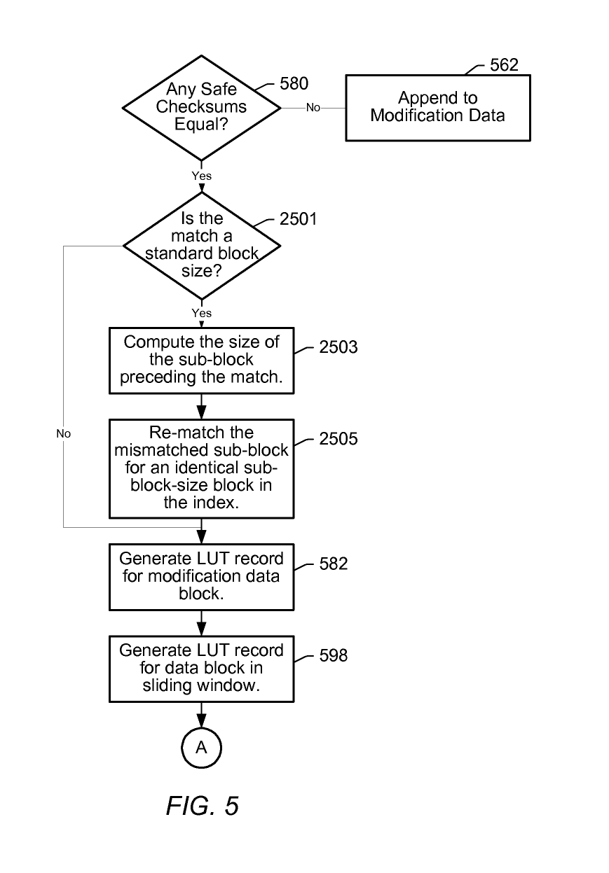

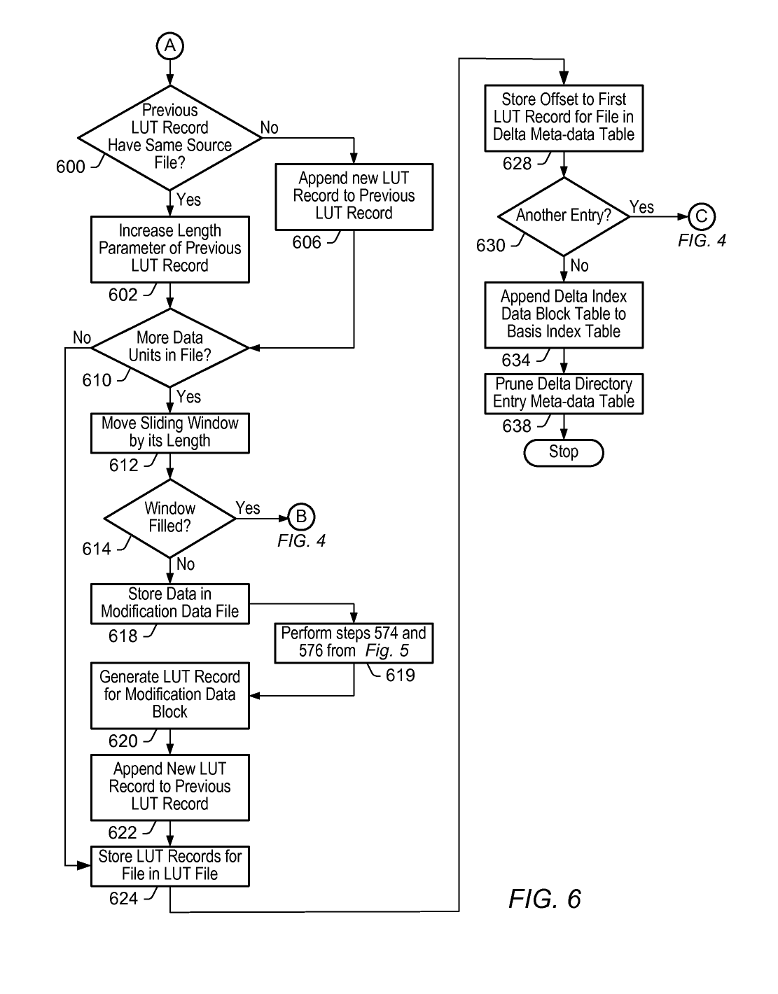

FIGS. 4, 5, and 6 are flowcharts of an embodiment of a system and method for generating a lookup table file (e.g., a delta lookup table file) and a modification data block file (e.g., a delta modification data block file may contain a subdirectory or file that is changed, deleted, or added) for an update to the representation of the original file system generated by the process shown in FIG. 3. Whenever a new version of a file system hierarchy is generated, either by changing, deleting or adding data to a file or its meta-data or by adding or deleting data files to the file system, a delta modification data block file and delta lookup table may be generated to provide the update information for the differences between the original file system hierarchy and the new version of the file system hierarchy. It is noted that on a space-constrained platform, the delta modification data block file may not be constructed.

In 500, the directory file for the new file system hierarchy may be read and entries for the subdirectories and files in the file system hierarchy may be identified. The meta-data for each entry (i.e., subdirectory or file) may be stored in a delta directory entry meta-data table in 504.

In 508, the basis directory entry meta-data table may be searched for an entry having the same name under the same parent as the entry currently being processed. In 510, if an entry is found in the basis directory entry meta-data table that corresponds to the entry currently being processed, 514 may be processed; otherwise, 512 may be processed.

In 512, 516, 522, 530 and 534, the value for a modification status variable may be set for the entry in the new file system hierarchy, as follows: 512 may set the modification status variable to “new”, 516 may set the modification status variable to “unmodified”, 522 may set the modification status variable to “modified”, 530 may set the modification status variable to “contents modified”, and 534 may set the modification status variable to “modified”. The modification status variable may be stored in the delta directory entry meta-data table.

In 514, if the meta-data for the entry currently being processed (which was stored in the delta directory entry meta-data table in 504) is the same as the meta-data for the entry in the basis directory entry meta-data table, 516 may be processed; otherwise, 520 may be processed.

In 520, if the entries are not files, 522 may be processed; otherwise, 526 may be processed. In 526, a safe checksum may be generated for the entry currently being processed (e.g., the data contents of the file entry in the new file system). In one embodiment, the iterative and/or safe checksum may be generated for the entry currently being processed.

In 528, the safe checksum computed in 526 may be compared to the safe checksum for the entire data content of the file stored in the basis directory entry meta-data table. If the two safe checksums are equal, 534 may be processed; otherwise, 530 may be processed. In one embodiment, the iterative and/or safe checksum computed in 526 may be compared to the iterative and/or safe checksum for the entire data content of the file stored in the basis directory entry meta-data table.

Following 512, 516, 522, 530 or 534, processing may continue with 536. In 536, it may be determined if another new entry is to be processed. If another new entry exists, processing may loop back to 504. If all entries in the new version of the original file system have been processed, processing may continue with 540.

In 540, a directory entry in the basis directory entry meta-data table may be selected and the delta directory entry meta-data table may be searched for a corresponding entry. The outcome of the search may be processed in 542: if no corresponding entry is located, 544 sets the modification status variable to “deleted” and an identifier for the entry may be stored in the delta directory entry meta-data table, processing may continue with 546. It is noted that 546 may also be processed if a corresponding entry is located.

In 546, it is determined if another basis index entry (e.g., an entry in the basis directory entry meta-data table) is to be processed. If another basis index entry exists, processing may loop back to 540. If all entries in the basis index directory entry meta-data table have been checked, processing may continue with 550.

In 550, an entry in the delta directory entry meta-data table may be selected. In 552, it may be determined whether the selected entry's modification status variable has a value of “new” or “contents modified”. If the value of the modification status variable is either “new” or “contents modified”, lookup table (LUT) records may be generated and data blocks stored in the delta modification data block file, if necessary, and processing may continue with 556. If the modification status variable has any other value, processing may loop back to 550.

In 556, a sliding window of N data units (e.g., 256 bytes) may be used to define data blocks. As noted before (see 460), the number N may be one of the block sizes used to segment files in the original file system for constructing the basis index data block table.

In 558, an iterative checksum may be computed for the first data block formed by the sliding window being placed at the first data unit of the data contents of the “new” or “contents modified” file. Because the iterative checksum has the property discussed above, the iterative checksum for each successive data block may only require calculations to remove the contribution of the data units removed from the block by moving the sliding window and to add the contributions of the data units added by moving the sliding window.

In 560, the iterative checksum computed in 558 for the first data block may be compared to the iterative checksums of the checksum identifiers stored in the basis index data block table to determine whether a corresponding entry may exist. If a corresponding entry exists in the basis index data block table, the safe checksum for the first data block may be computed and compared to the safe checksums of the checksum identifiers selected from the basis index data block table. Only one, if any, safe checksum of the checksum identifiers may be the same as the safe checksum computed for the first data block. An iterative checksum may be computed for each successive data block (as discussed in 558), and each iterative checksum may be compared to the iterative checksums of the checksum identifiers stored in the basis index data block table to determine whether a corresponding entry may exist. If a corresponding entry exists in the basis index data block table for any particular successive data block, the safe checksum for that particular data block may be computed and compared to the safe checksums of the checksum identifiers selected from the basis index data block table. Only one, if any, safe checksum of the checksum identifiers should be the same as the safe checksum computed for each successive data block.

In 580, if a corresponding safe checksum is identified, the data blocks may be the same (i.e., a match has been found), and processing may continue with 582; otherwise, processing may continue with 562 (see below).

In one embodiment, when a match is found in 580, in 2501 (see FIG. 5), if that match is of a standard block size, the size of the sub-block immediately preceding the match may be computed in 2503 and that mismatched sub-block may be re-matched for an identical sub-block-size block in the index in 2505. Following the sub-block matching process, processing may continue after the already matched sliding window. In one embodiment, if the match is not of a standard block size, processing may continue at 582. In one embodiment, if a match is not found, processing may continue at 562 (see FIG. 4). Other processes are also contemplated.

For example, if a fixed length data block is 256 bytes, there may be up to 255 sub-blocks for the fixed length data block (i.e., sub-block 1 of 256, containing 1 byte; sub-block 2 of 256, containing 2 bytes; up to sub-block 255, containing 255 bytes). The size of these arbitrary sub-blocks may be identified when a match occurs at the standard block size.

This embodiment of indexing all sub-block size mismatches may allow the matching of sub-blocks that typically occur at the ends of files. Additionally, indexing sub-blocks insures that data added subsequently to the baseline version is fully indexed for subsequent matching. Indexing of sub-blocks may insure full indexing because matches against existing indexes (e.g., the baseline version or some subsequent version) may break up the data and leave holes that are less than block size.

For example, consider the case of file A, present in the baseline version, which is modified by a second version to state A′, with two copies of A′ being present in the second version. Further suppose that A′ is simply A with one byte removed from offset 0. When the data of the second version is processed, no match may be found on the first (e.g., 256 byte) block in the first instance of A′. However, a match may be found at offset 255 (i.e., the match being the base state A at offset 256). Hence 255 bytes may be added to the delta modification data block file and the first instance of A′ may reference the data from there. If the sub-block indexing embodiment were not implemented, however, those 255 bytes (i.e., less than standard block size of 256 bytes) may not be indexed. Consequently, when the second instance of A′ is processed, if the sub-block indexing embodiment is not implemented, the same 255 bytes may be added for a second time to the delta modification data block file and the second instance of A′ may reference the data from there. Similarly, subsequent modifications may continue to add another copy of the same 255 bytes to the delta modification data block file (if the sub-block indexing embodiment is not implemented).

In 562, data units of the data block may be appended to the delta modification data block file if either of the following conditions exist: (1) there is no corresponding iterative checksum in the basis index data block table for the data unit; or (2) the safe checksum for the data unit does not match the safe checksums of the checksum identifiers selected from the basis index data block table. As noted above, on a space-constrained platform, the delta modification data block file may not be constructed.

In 572, the cumulative number of data units stored in the delta modification data block file in 562 may be compared to the number of data units for a data block. If these numbers are not equal, processing may loop back to 556 in which the sliding window may be moved to remove the previous data unit from the data block in the file being processed and to add the next data unit. If these numbers are equal, processing may continue with 574.

In 574, the iterative and safe checksums for the data block may be generated to form a checksum identifier for the data block. In one embodiment, the checksum identifier may represent the iterative and safe checksums. The iterative checksum and the safe checksum for the data block of modification data may be stored as the primary key and the qualified key, respectively, in a delta index data block table associated with the new version of the original file system.

In 576, an identifier of the delta modification data block file in which the data block is stored and the offset into that file that defines the location of the first data unit for the data block being processed may be stored in the delta index data block table in association with the iterative and safe checksums. Processing may loop back to 556 in which the sliding window is moved to remove the previous data unit from the data block in the file being processed and to add the next data unit.

In another embodiment, 576 may update the basis index data block table (rather than the delta index data block table) with the above noted information. That is, the basis index data block table may be updated to contain a basis index data block record for each new block of modification data as that block of modification data is processed. If this alternative 576 is used, 634 (see below) would no longer be necessary, as there would no longer be a delta index data block table. The new version of the file system hierarchy may contain new or modified files in which the same new block of modification data appears more than once, but the generated representation of the new version of the original file system hierarchy will only contain a single copy of the new block of modification data. For example, if the original file system hierarchy is empty, this embodiment may generate an efficiently compressed representation of a file system hierarchy.

In 582, a lookup table (LUT) record may be generated. On a space-constrained platform, the LUT record for the new data may refer to a block of data directly within the original source file (as selected in 550). On non-space constrained platforms, the LUT record may be generated for the data units stored in the delta modification data block file since the last corresponding checksum identifier was detected. That is, all of the data following the identification of the last data block that is also in the basis index data block table may be stored in the delta data modification file and the LUT record for that data indicates that the data is a contiguous block of data. The LUT record may be comprised of a delta modification data block file identifier, an offset from the first data unit in the modification data file to the contiguous data block stored in the modification data file, a number of data units in the contiguous data block stored in the modification data file, and an offset of the data block in the file currently being processed. The first three data elements in the LUT record may identify the source file for the data block in the new version of the original file system and its location in that file while the fourth data element defines the location of the data block in the file of the new version of the original file system. As discussed below, this may permit the application program that controls access to the new version of the original file system to not only know from where it may retrieve the data block but where it goes in the new version of the file. It is noted that if the delta modification data block file is empty, the LUT record may not be generated.

In 598, a new LUT record may be generated for the data block within the sliding window. At this point in the process, the checksum identifier for the data block within the sliding window may have been identified as being the same as a checksum identifier in the basis index data block table. As this block may already exist in a file in the original version of the file system, an LUT record may be generated to uniquely identify the data block within the sliding window. The LUT record for the data block that corresponds to the checksum identifier stored in the basis index data block table may include the same source file identifier as the one in the basis index data block table, the same offset from the start of the source file, the same data block length stored in the basis index data block table, and the offset of the data block in the file currently being processed.

In 600, if the previous LUT record for the file being processed has a source file identifier that is the same as the one for the newly generated LUT record for the data block within the sliding window and the newly generated LUT record is for a data block that is contiguous with the data block identified by the previous LUT record, processing may continue with 602; otherwise, processing may continue with 606. Following either 602 or 606, processing may continue with 610.

In 602, the length of the data block in the newly generated LUT record may be added to the length stored in the previous LUT record, and the newly generated LUT record may be discarded. This corresponds to the situation where contiguous blocks of the data in a file of the new version of the original file system may be the same as a group of contiguous blocks in a file of the original file system. Thus, one LUT record may identify a source for the contiguous group of blocks.

In 606, the newly generated LUT record may be appended to the previous LUT record. This corresponds to the situation where the data block for the newly generated LUT record may be either not contiguous with the data block of the previous LUT record or the data block for the newly generated LUT record may not be from the same source file as the data block of the previous LUT record.

In 610, it may be determined if additional data units exist in the file to be processed. If all data units in the file have been processed, processing may skip ahead to 624; otherwise, processing may continue with 612.

In 612, the sliding window may be moved by its length to capture a new data block. In 614, it may be determined whether the number of remaining data units fill the sliding window. If the sliding window is filled, processing may loop back to 558. Otherwise, processing may continue with 618.

In 618, the remaining data units may be stored in the delta modification data block file. As noted above, on a space-constrained platform, the delta modification data block file may not be constructed.

The processing for 619 may correspond to the processing for 574 and 576 from FIG. 4. Refer to these processes (above) for the complete description.

In 620, a corresponding LUT record may be generated. On a space-constrained platform, the corresponding LUT record may refer to a block of data directly within the original source file. On non-space constrained platforms, the corresponding LUT record may refer to the delta modification data block, and the delta modification data block may be indexed as a sub-block-sized block containing the data at the end of the file.

The LUT records generated for the file being processed may be appended to the LUT records for other files previously stored in an LUT file for the new version of the original file system in 622. The LUT records for the file may be stored in the LUT file in 624. The offset for the first LUT record for the file being processed and the number of LUT records for this file may be stored in the meta-data of the delta directory entry meta-data table for the file being processed in 628.

In 630, it may be determined if another entry in the delta directory entry meta-data table remains to be processed. If another entry exists, processing may loop back to 550. If all entries in the delta directory entry meta-data table have been processed, processing may continue with 634. It is noted that if the alternative 576 is used (see above), 634 may be eliminated. In that case, processing would continue with 638.

In 634, the delta index data block table may be appended to the basis index data block table. In 638, the delta directory entry meta-data table for the entries in the new version of the original file system may be searched for any entries having a value of “unmodified” for the modification status variable. These entries and their meta-data may be removed (i.e., pruned) from the delta directory entry meta-data table unless they have a descendant having a value other than “unmodified” for the modification status variable.

In an embodiment that utilizes previous updates provided for the original file system, the above process may be modified to evaluate the delta index data block tables for previous versions of the original file system. Specifically, the process may search the basis index data block table file and the delta index data block tables file(s) for update versions to locate data blocks having corresponding iterative and safe checksums for corresponding “new” or “contents modified” files in the latest version. Additionally, the source of data blocks may also include delta modification data files for previous update versions of the original file system as well as the files of the original file system and the delta modification data block file for the latest version.

Alternatively, to limit the growth in the size of the LUT records for frequently modified files, each new LUT record may recursively reference the previous LUT record. This recursive referencing may significantly reduce the space consumed.

For example, consider a large database that changes frequently. The LUT records for this database (without recursive referencing) may quickly become fragmented (e.g., tens of thousands of LUT entries). Every version that contains a change to this database file may also contain a large amount of LUT data for this file alone, even if the total new data for the file is very small. Since the file is only slightly changed since the previous version, the LUT record for the current version may be logically very similar to that generated in the previous version. Suppose that the large database consists of 10,000 LUT entries each mapping exactly 100 bytes. If the current version (i.e., version N) modifies one byte at offset 10,000, without recursive referencing the current version may contain all 10,000 new LUT entries. Using recursive referencing, there may be 3 LUT entries, as follows: (1) 0-9999 to 0-9999 from amendment N−1; (2) 10000-10000 to 0 from new data; (3) 10001-999999 to 10001-999999 from amendment N−1. To reconstruct the correct LUT when desired, reference to the previous version's LUT record may be required.

Producing a recursive representation of the LUT record may be done by any known differencing algorithm (e.g., longest-common-subsequence matching) taking the new and old LUT records for the files in question as input. To allow this comparison, the source file references in the LUT records may be translated into a common logical identification space for both the old and the new LUT records. Specifically, the LUT record native representation wherein the source file is identified by its offset in the corresponding directory map may not be directly used without matching these directory map offsets back to their logical entities (e.g., the directory entries) as they may otherwise not necessarily match even for the same source file. This translation may be performed logically by the comparison function utilized by the differencing algorithm. Thus, when it is called upon to compare two LUT records from the current and previous versions it may use the offsets in the LUT records in question to lookup the corresponding entry in the corresponding directory maps and may only indicate a match if these referenced entities are the same (e.g., by full path name).

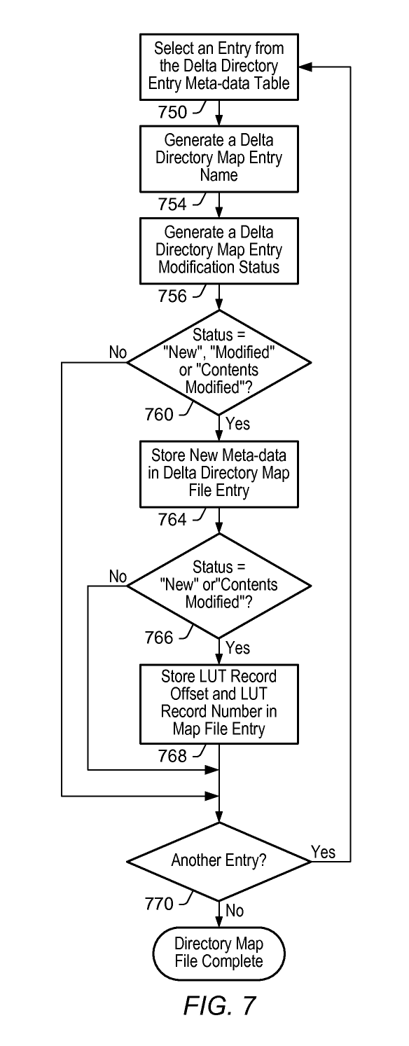

FIG. 7 is a flowchart of an embodiment of a system and method for generating a delta directory map file for the new version of the original file system from the delta directory entry meta-data table generated by the process shown in FIGS. 5 and 6.

In 750, an entry in the delta directory entry meta-data table may be selected. An entry in the delta directory map file system may be generated, including the name of the entry (754) and a value for the modification status variable for the entry (756). In 760, it may be determined whether the newly generated entry's modification status variable has a value of “new”, “modified”, or “contents modified”. If the modification status variable has a value of either “new”, “modified”, or “contents modified”, the new meta-data may be stored in the delta directory map file for the entry (764) and processing may continue with 766. If the modification status variable has any other value, processing may proceed to 770.

In 766, it may be determined whether the newly generated entry's modification status variable has a value of “new” or “contents modified”. If the modification status variable has a value of either “new” or “contents modified”, the offset to the first LUT record for the file in the LUT file and the number of LUT records for the file in the LUT file may be stored in the delta directory map file (768) and processing may continue with 770. If the modification status variable has any other value, processing may proceed to 770.

In 770, it may be determined if another entry is to be processed. If another entry exists, processing may loop back to 750. If all entries in the delta directory entry meta-data table have been processed, the delta directory map file may be complete. The name of the new file system hierarchy, its version identifier, directory map file, LUT file, and modification data files may be compressed for delivery to a system having a copy of the original file system.

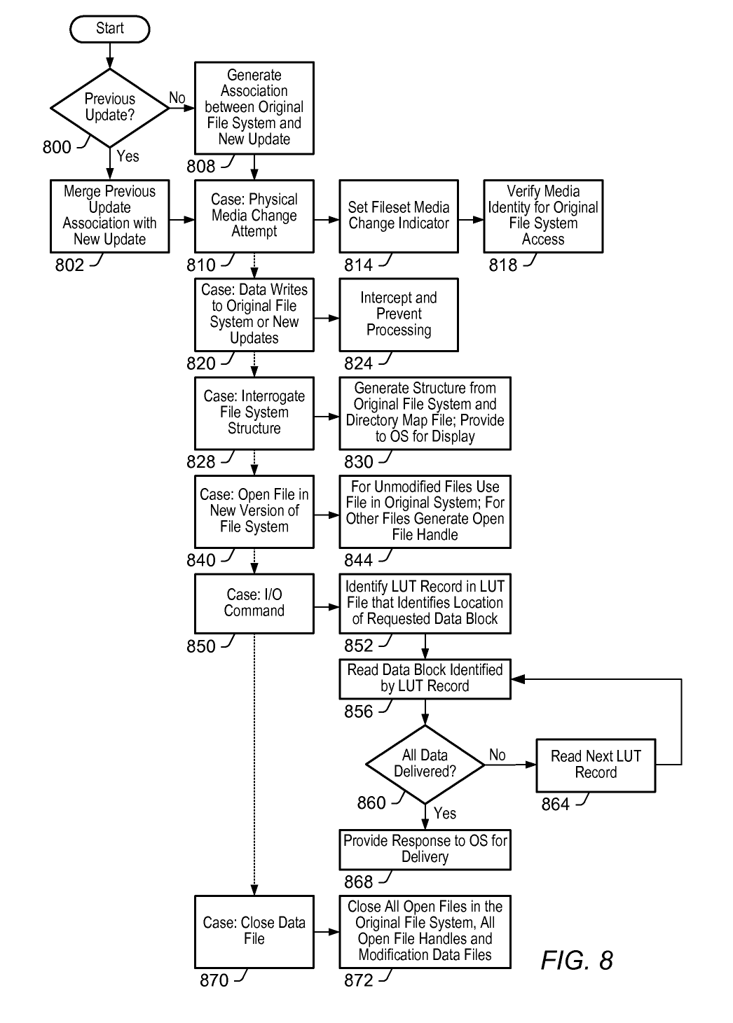

FIG. 8 is a flowchart of an exemplary process that uses the files for an update generated by the process shown in FIGS. 5, 6 and 7 to generate a latest version of the original file system according to one embodiment.

A compressed representation of the new version of the original file system may be transferred to a computer on which a copy of the original file system hierarchy is stored. Subsequently, the compressed representation of the new version of the original file system may be used to update the original file system. An application program may be provided as part of that representation to perform the process depicted in FIG. 8. In another embodiment, the application program may be part of the interface program provided for accessing the content of the original file system hierarchy such as an extension to the file system program of the recipient computer. The program may decompress the representation of the new file system hierarchy and store the delta directory map file, the LUT file, and the delta modification data block file in storage accessible to the computer. It is noted that any recursive compression of the LUT file may be decompressed to construct a LUT in non-recursive format.

In 800, it may be determined whether a directory containing a delta modification data block file for a previous version of the original file system hierarchy is associated with a directory or drive containing the original file system hierarchy. If there is an association with a directory containing a delta modification data block file, processing may continue with 802; otherwise, processing may continue with 808. Both 802 and 808 may be followed by 810.

In 802, the previous update association may be merged with an association between the directory where the decompressed files for the new file system hierarchy are stored and the drive or directory where the original file system hierarchy is stored. The merge replaces the existing associated delta directory map file and LUT file with the new delta directory map file and LUT file, but leaves any existing delta modification data block files referenced in the new LUT file.

In another embodiment, 802 may retain the existing associated delta directory map file and LUT file, for purposes of recalling a particular version of the file system at a particular point in time. If this alternative 802 were used, the user may be able to select which of a number of available versions of a file system hierarchy is accessed when the user attempts to access the original file system hierarchy. Such a selection mechanism may provide an accessible archive of multiple versions of the file system hierarchy.

In 808, an association may be created between the drive or directory where the original file system hierarchy may be stored and the directory where the downloaded decompressed files for the new version of the original file system hierarchy may be located.

The application program may be coupled to the operating system of the computer in which a copy of the original file system hierarchy and the decompressed files for the new version of the file system hierarchy may be stored. In a known manner, the operating system is modified to detect any attempted access to the drive or directory containing the original file system hierarchy or the files for the new version of the file system hierarchy. In 810, 820, 828, 840, 850 and 870, various attempted access operations to the drive or directory may contain the original file system hierarchy or the files for the new version of the file system hierarchy. Various responses to the attempted access operations may follow.

In 810, the attempted operation may be to change the physical media for the original file system hierarchy. The response to 810 may involve: in 814 the application program may store a media change indicator followed by a verification of the identity of the physical media when a subsequent attempt is made to access the original file system hierarchy in 818. If the physical media has changed, the application change program may check the media change indicator and determine whether the original file system media is available. If it is not, the program may indicate that the original file system hierarchy is not available for access by the user. Otherwise, the access may be processed.

In 820, the attempted operation may be to write data to the drive or directory containing the original file system hierarchy or the files for the new version of the original file system detected by the application program. The response to 820 may be 824 in which the write operation is intercepted and it is not processed.

In 828, the attempted operation may be an interrogation of the structure of the original file system hierarchy (e.g., a directory enumeration command). The response to 828 may involve building data in two passes and presenting that data to the user. In 830, the application program may retrieve the requested structure data from the original file system and delete the entries for which the value of the modification status variable in the delta directory map file is “deleted”, “new”, “modified”, or “contents modified”. The data for these entries may be obtained from the delta directory map file and used to modify the structure data responsive to the structure query. That is, the application program may obtain the data to be displayed for the original file system hierarchy, delete those files corresponding to delta directory map file entries having “deleted” as the value of the modification status variable, adding structure data for those entries in the directory map file having a status of “new”, and modify the structure data for those entries in the directory map file having a status of “modified” or “contents modified”. This data may be provided to the operating system for display to the user.

In 840, the attempted operation may be to open a file in the new version of the original file system hierarchy. The response to 840 is 844 in which the application program determines the value of the modification status variable for the file. If the modification status is “unmodified”, the operation may be processed using the contents of the original file system only. Otherwise, the application program may construct and return an open file handle that identifies the file. The open file handle may identify the file for subsequent file operation commands but does not necessarily open any underlying file. For any file system operation command that interrogates the properties of a file for which an open file handle exists, the application program returns data from the delta directory map file entries that correspond to the file identified by the open file handle.

In 850, the attempted operation may be an I/O operation command that reads data from a file identified by an open file handle. The response to 850 may be 852 in which the application program identifies the LUT record in the LUT file that corresponds to the start of the requested data block. If the underlying file referenced in the LUT record is not opened, the application program may open the underlying file and associate it with the open file handle. The application program may read from the LUT record whether the data for the requested data block is to be read from the original file system hierarchy or one of the delta modification data block files. After the source file is identified, the offset data and data block length may be used to locate the first byte to be transferred from the identified source file and the number of bytes to be transferred, respectively. In 856, the corresponding number of bytes may be transferred from the source file to a response file being built. In 860, it may be determined whether all of the data has been delivered. If there is more data to be delivered, 864 may be processed; otherwise, 868 may be processed. In 864, the next LUT record may be read to extract data to be appended to the response file initially created in 856, followed by processing returning to 856. This process (i.e., 856, 860, and 864) may continue until the data transferred for an LUT record provides all of the data requested or until the last entry for the file is reached (i.e., in 860 it is determined that all of the data has been delivered). In 868, the response file built from the transfer of data from the source files identified by the LUT records may be provided to the operating system for delivery to the requesting program. In this manner, a response may be provided to a file system operation that appears to be the result of a single contiguous read operation.

In 870, the attempted operation may be to close a data file. The response to 870 may be 872 in which the application program closes all corresponding files in the original file system hierarchy and the data files for the new file system hierarchy.

FIGS. 3 through 8 describe an embodiment where the set of data objects may be a directory hierarchy of a file system and the data objects are files. It is noted that another embodiment may have the set of data objects represented by any structure of identified objects that contain data. For example, a directory services hierarchy representing objects used to manage a computer network may be another embodiment. Other similar examples would be obvious to those skilled in the art.

In one embodiment, a compact representation of the differences between an original version of a file system hierarchy and an updated version of the file system hierarchy may be generated. Multiple versions of the file system hierarchy may be maintained in multiple compact representations. This may allow for the regeneration of any updated version of the file system hierarchy from the original version of the file system hierarchy, by using one or more of the generated compact representations. It is noted that another use of the compact representations is to back up a file system hierarchy or to back up updates to a file system hierarchy to allow that version to be restored at a later date. Therefore, the sequence of generated compact representations may be used to restore any version of the file system hierarchy.

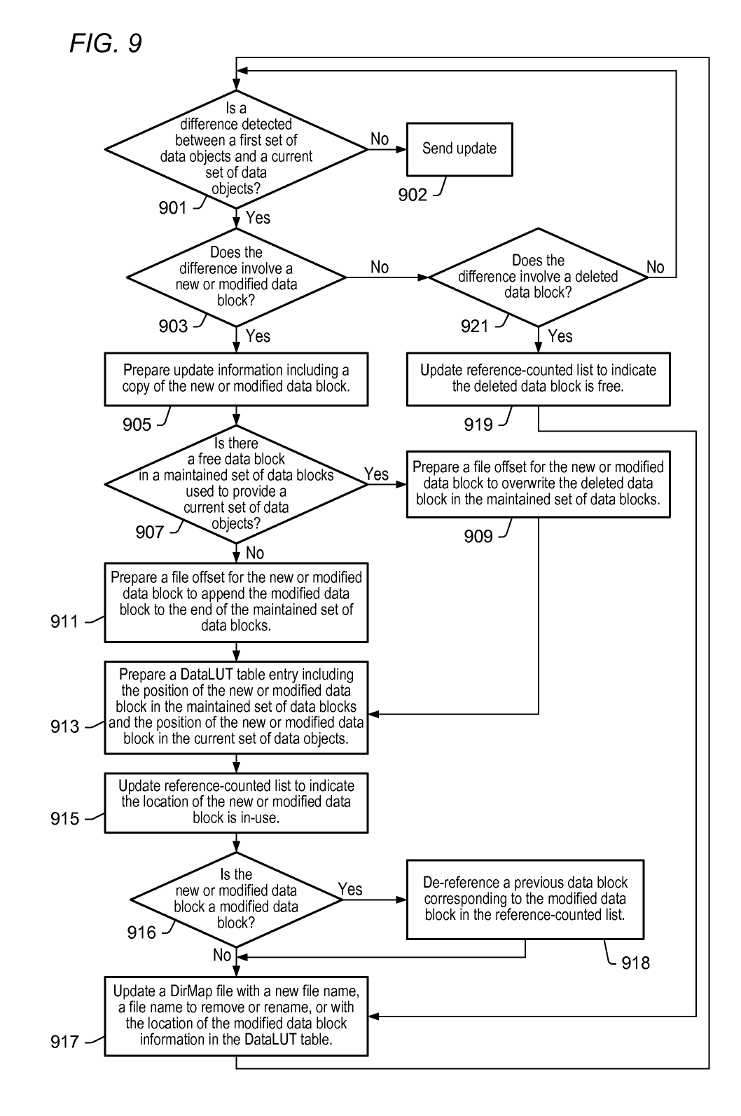

FIG. 9 is an embodiment of a flowchart for preparing an update in a first fit data blocks file management scheme. In one embodiment, a publisher may be included on a central computer system to distribute/update data on client computer systems coupled to the publisher. In one embodiment, the client computer system may be a personal digital assistant. In one embodiment, a file system may be virtually represented using a maintained set of data blocks and one or more reference files, such as but not limited to, the DataLUT file (e.g., the LUT file discussed above) and the DirMap file (e.g., the directory map file discussed above). In one embodiment, the maintained set of data blocks may be a smallest set of data blocks needed to represent the new file system. In one embodiment, the maintained set of data blocks may be stored on both the publisher and the client computer system. In one embodiment, the maintained set of data blocks may be stored on only the client computer system. Other storage locations for the maintained set of data blocks are also contemplated. Updates to the maintained set of data blocks may be created by the publisher by comparing a version of the data objects such as, but not limited to, a first set of data objects, to the current version of the data objects. The publisher may provide the client computer system with update packets containing data blocks, file offsets for the data blocks, and reference file addendums, such as but not limited to DataLUT entries and DirMap entries to apply to the copy of the maintained set of data blocks and reference files on the client computer system. The client computer system may provide a virtual version of the file system using the updated maintained set of data blocks and updated reference files. In one embodiment, the file offsets may be used to place the new or modified data blocks (i.e., a modification data block) in the maintained set of data blocks. It should be noted that in various embodiments of the methods described below, one or more of the processes described may be performed concurrently, in a different order than shown, or may be omitted entirely. Other additional processes may also be performed as desired.

In 901, a publisher may detect differences between a first set of data objects and a current set of data objects. In one embodiment, a baseline of the first set of data objects may be constructed and compared to the current set of data objects. Also, as discussed above, iterative checksums and safe checksums may be calculated for data blocks in the first set of data objects and compared to calculated iterative checksums and safe checksums of data blocks for the current set of data objects to find differences between them. For example, in one embodiment, differences between the first set of data objects and the current set of data objects may comprise new data blocks, modified data blocks, or deleted data blocks. If no more differences are detected, at 902, the publisher may send the detected differences in an update packet to the client computer system. If no differences were detected at all, the publisher may not send the update packet to the client computer system.

In 903, if a difference is detected, a publisher may determine if the detected difference involves a new data block or a modified data block. In 905, if the difference does involve a new data block or a modified data block, the update packet may be prepared to include a copy of a modification data block (e.g., the new data block or the modified data block). For example, if the current set of data objects has a new data block that is not found in the first set of data objects, the new data block may be included in the update packet. In another example, if a data block in the current set of data objects is a modified version of a data block in the first set of data objects, the modified data block may be included in the update packet.

In 907, the publisher may determine if there is a free data block in a maintained set of data blocks used to provide a current set of data objects. In one embodiment, a data block may be designated as a free data block in a reference counted list maintained on the publisher if the data block has been deleted and/or is no longer used. In one embodiment, the publisher may use the reference counted list (e.g., a file with a data block list) to identify “free” and “in-use” data blocks.

In 909, if there is a free data block in the maintained set of data blocks, a file offset for the new data block or the modified data block may be prepared to overwrite the free data block in the maintained set of data blocks. For example, the file offset may reference the position of the free data block.

In 911, if there is not a free data block in the maintained set of data blocks, a file offset may be prepared for the new data block or the modified data block to append the new data block or the modified data block to the end of the maintained set of data blocks. For example, the file offset may reference a position at the end of the maintained set of data blocks.

In 913, a DataLUT entry may be prepared to include the position of the new data block or modified data block in the maintained set of data blocks and the position of the new data block or modified data block in the new version of the file system. The DataLUT entry for the DataLUT file may be used to point to positions of the data blocks in the maintained set of data blocks used in the new version of the file system.

In 915, the reference counted list may be updated to indicate that the position of the new data block or the modified data block is “in use”. In one embodiment, the publisher may use “free” and “in-use” designations in the reference counted list to indicate which data blocks in the maintained set of data blocks are still needed for the new version of the file system. Other designations are also contemplated. In one embodiment, data blocks that are no longer needed may be marked as free in the reference counted list.

In 921, if the difference did not involve a new data block or a modified data block at 903, the publisher may determine if the difference involves a deleted data block. If the difference did not involve a deleted data block, a new difference may be detected at 901.

In 919, if the difference did involve a deleted data block, the reference counted list may be updated to indicate the deleted data block position is “free”. For example, future new or modified data blocks may be stored in the now free data block position (previously used by the now deleted data block).

In 916, if the new data block or modified data block is a modified data block, in 918, a previous data block corresponding to the modified data block may be de-referenced in the reference counted list to make the previous data block in the reference-counted list a “free” data block. If the new data block or modified data block is a new data block, processing may continue at 917. Other processes for modified data blocks are also contemplated.

In 917, the DirMap file may be updated with a new filename, a renamed filename, a filename to remove, or with the location of the new or modified data block information in the DataLUT file. In one embodiment, the DirMap file may provide a map of the file hierarchy of the file system. For example, if a new file is added to the first set of data objects (i.e., the current set of data objects has a file not in the first set of data objects) new data blocks with the new file's data may be sent in update packets along with a DirMap entry noting a new file's name and position in the file system hierarchy. In one embodiment, a DirMap entry may also have pointers to data block information (such as, but not limited to, a position in the maintained set of data blocks and their size) in the DataLUT file. In one embodiment, the process may continue back at 901.

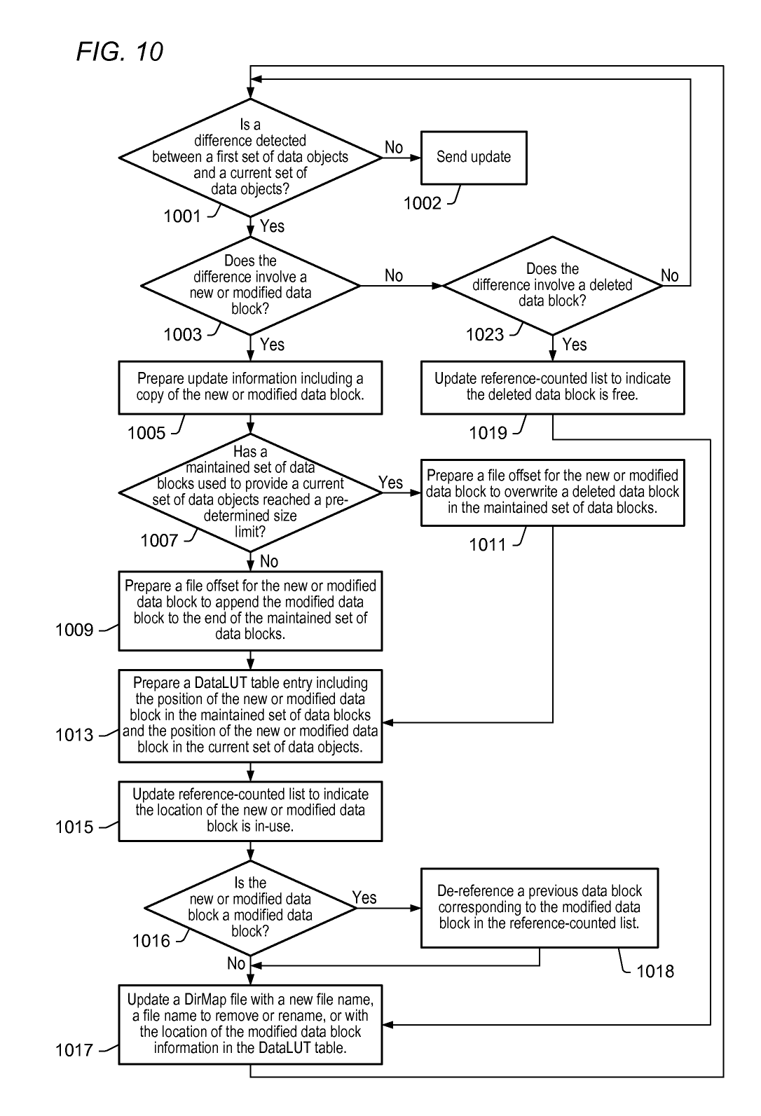

FIG. 10 is an embodiment of a flowchart for preparing an update in a least recently used data blocks file management scheme. It should be noted that in various embodiments of the methods described below, one or more of the processes described may be performed concurrently, in a different order than shown, or may be omitted entirely. Other additional processes may also be performed as desired.

In 1001, a difference may be detected between a first set of data objects and a current set of data objects. If no additional differences are detected, at 1002, the publisher may send the detected differences in an update packet to the client computer system. If no differences were detected at all, the publisher may not send the update packet to the client computer system.

In 1003, the publisher may determine if the difference involves a new data block or a modified data block.

In 1005, if the difference involves a new data block or a modified data block, update information may be prepared to include a copy of the new data block or modified data block.

In 1007, the publisher may determine if a maintained set of data blocks used to provide a current set of data objects has reached a pre-determined size limit. In one embodiment, data blocks may not be overwritten until the maintained set of data blocks has reached a pre-determined size limit. For example, the pre-determined size limit may be the size of a storage medium used by the client computer system. Other pre-determined size limits are also contemplated. In one embodiment, the publisher may fill the maintained set of data blocks to the pre-determined size limit first to keep copies of data blocks no longer referenced by the DataLUT file or needed to create the new file system in case these data blocks become needed again.

In 1009, if the maintained set of data blocks has not reached the pre-determined size limit, a file offset may be prepared for the new data block or the modified data block to append the modified data block to the end of the maintained set of data blocks.

In 1011, if the maintained set of data blocks has reached the pre-determined size limit, a file offset may be prepared for the new data block or modified data block to overwrite a deleted data block in the maintained set of data blocks.

In 1013, a DataLUT entry including the position of the new data block or the modified data block in the maintained set of data blocks and the position of the new data block or the modified data block in the current set of data objects may be created. As discussed above, the DataLUT entry may assist in referencing data blocks used in the new version of the file system.

In 1015, the reference counted list may be updated to indicate the position of the new data block or the modified data block is “in use”. For example, the position now occupied by the new or modified data block may be reserved for the new or modified data block so that the new or modified data block is not overwritten until it is deleted in future updates.

In 1023, if the difference at 1103 did not involve a new data block or a modified data block, the publisher may determine if the difference involves a deleted data block. If the difference did not involve a deleted data block, a new difference may be detected at 1101.

In 1019, if the difference did involve a deleted data block, the reference counted list may be updated to indicate the deleted data block position is “free”.

In 1016, if the new data block or modified data block is a modified data block, in 1018, a previous data block corresponding to the modified data block may be de-referenced in the reference counted list to make the previous data block in the reference-counted list a “free” data block. If the new data block or modified data block is a new data block, processing may continue at 1017. Other processes for modified data blocks are also contemplated.

In 1017, a DirMap file may be updated with a new filename, a renamed filename, a filename to be removed, or with the location of the new data block or the modified data block information in the DataLUT file. In one embodiment, the process may continue at 1001.

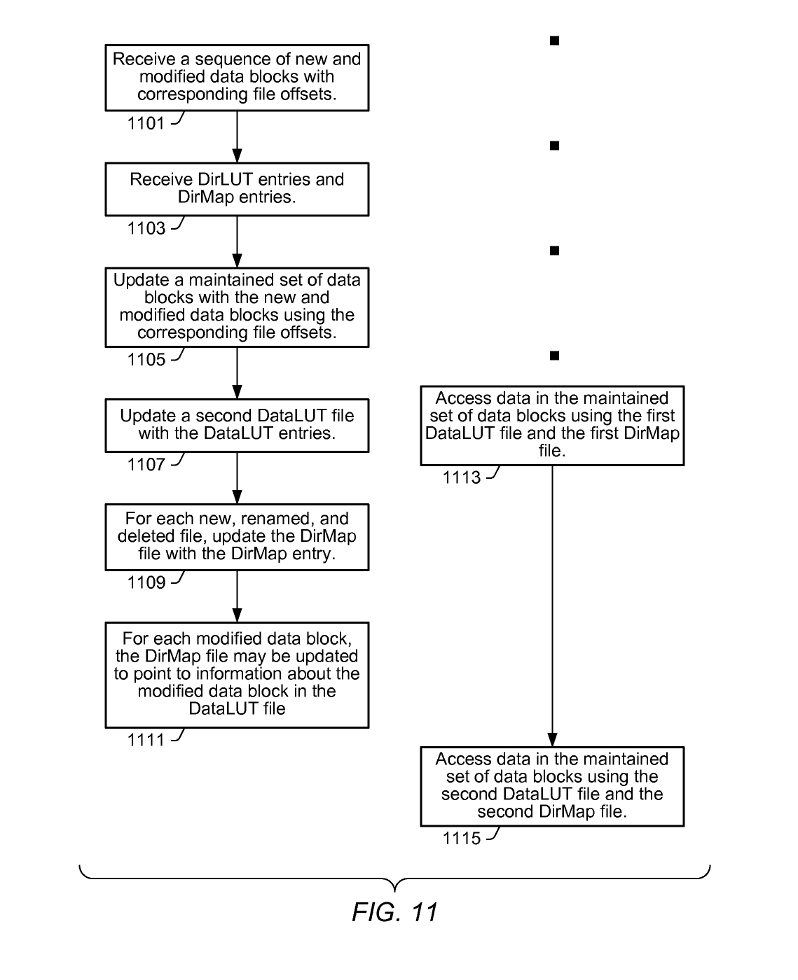

FIG. 11 is an embodiment of a flowchart for updating a client. It should be noted that in various embodiments of the methods described below, one or more of the processes described may be performed concurrently, in a different order than shown, or may be omitted entirely. Other additional processes may also be performed as desired.

In 1101, a sequence of new data blocks and/or modified data blocks may be received with corresponding file offsets. In one embodiment, the file offsets may be used to put the new data block or modified data block in the maintained set of data blocks.

In 1103, DirLUT entries and DirMap entries may be received. In one embodiment, other reference files may be used. In another embodiment, no reference files may be used.

In 1105, a maintained set of data blocks may be updated with the new data blocks and modified data blocks using the corresponding file offsets. For example, deleted data blocks may be overwritten with new data blocks or modified data blocks. In addition, data blocks may be appended onto the end of the maintained set of data blocks.

In 1107, a second DataLUT file may be updated with the DataLUT entries. In one embodiment, the DataLUT file may have DataLUT entries appended onto the end of the DataLUT file. In one embodiment, recursive entries in the DataLUT file may be consolidated into one entry in the DataLUT file. The DataLUT file may reference data blocks in the maintained set of data blocks needed for corresponding files in the new file system.

In 1109, for each new, renamed, and deleted file, the DirMap file may be updated with the DirMap entry. The DirMap file may provide a file hierarchy for the file system. In one embodiment, the DirMap file may not be used.

In 1111, for each modified data block, the DirMap file may be updated to point to information about the modified data block in the DataLUT file.

In 1113, data may be accessed in the maintained set of data blocks using the first DataLUT file and the first DirMap file at substantially the same time as the second DataLUT file is updated with the DataLUT entries at 1107.

In 1115, after the second DataLUT file is updated with the DataLUT entries, the data in the maintained set of data blocks may be accessed using the second DataLUT file and the second DirMap file. In one embodiment, the client computer system may use only one version of the DataLUT file and DirMap file.

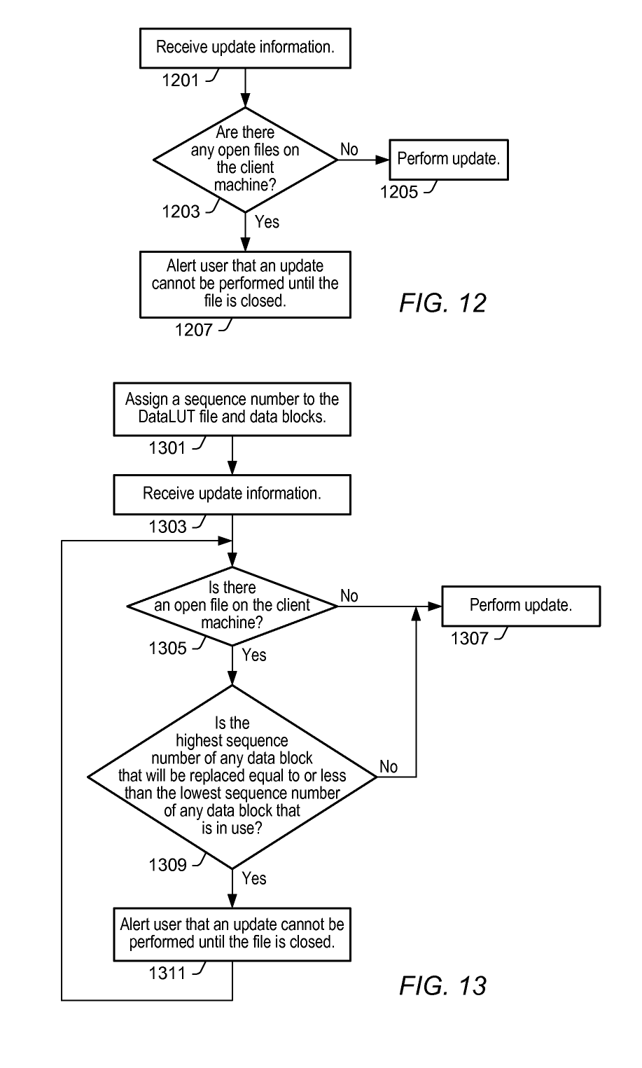

FIG. 12 is an embodiment of a flowchart for managing open files during an update. It should be noted that in various embodiments of the methods described below, one or more of the processes described may be performed concurrently, in a different order than shown, or may be omitted entirely. Other additional processes may also be performed as desired.

In 1201, update information may be received. For example, update information may include data blocks, file offsets, DataLUT entries, and/or DirMap entries. Other update information is also contemplated.

In 1203, software executing on the client computer system may determine if there are any open files on the client machine. For example, a user of the client computer system may be accessing a file in the file system. In one embodiment, the DataLUT file and/or DirMap file may be open.

In 1205, if there are no open files on the client machine, an update may be performed.

In 1207, if there are open files on the client machine, a user may be alerted that an update cannot be performed until the open files are closed. In one embodiment, the client computer system may indicate which open file needs to be closed. In one embodiment, the maintained set of data blocks may be updated before the user has a chance to open a file.

FIG. 13 is an embodiment of a flowchart for using sequence numbers to manage open files during an update. It should be noted that in various embodiments of the methods described below, one or more of the processes described may be performed concurrently, in a different order than shown, or may be omitted entirely. Other additional processes may also be performed as desired.

In 1301, an update sequence number may be assigned to the DataLUT file and data blocks sent in the update packet. For example, each new or modified data block will receive the update sequence number. Other data blocks that are reused (i.e., not modified or deleted) will keep the update sequence number assigned to them when they were first added. An original set of data blocks may have the lowest sequence number. In one embodiment, the least recently used management scheme may be used (i.e., only reusing free blocks if the maintained set of data blocks has reached a pre-determined limit).

In 1303, update information may be received by the client computer system.

In 1305, the client computer system may determine if there is an open file on the client machine.

In 1307, if there is not an open file on the client computer system, an update may be performed.

In 1309, the client computer system may determine if the highest sequence number of any data block that will be replaced is equal to or less than the lowest sequence number of any data block that is in use for an open file.

In 1311, if the highest sequence number of any data block that will be replaced is equal to or less than the lowest sequence number of any data block that is in use for an open file, a user may be alerted that an update cannot be performed until the file is closed.

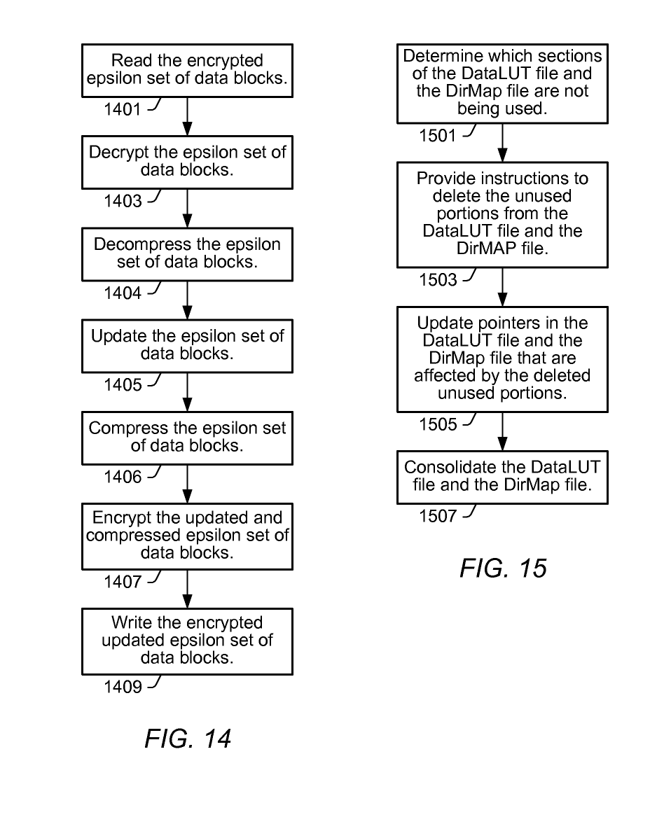

FIG. 14 is an embodiment of a flowchart for encrypting an updated data blocks file. It should be noted that in various embodiments of the methods described below, one or more of the processes described may be performed concurrently, in a different order than shown, or may be omitted entirely. Other additional processes may also be performed as desired.

In 1401, an encrypted maintained set of data blocks may be read. In one embodiment, the maintained set of data blocks may be encrypted on the client computer system. In one embodiment, the update packets sent to the client computer system may be encrypted.

In 1403, the maintained set of data blocks may be decrypted. In one embodiment, public key and/or symmetric key encryption schemes may be used. Other encryption schemes are also contemplated.

In 1404, the maintained set of data blocks may be decompressed. In one embodiment, the maintained set of data blocks may not need to be decompressed.

In 1405, the maintained set of data blocks may be updated. For example, the update packet may include a new data block with a corresponding file offset, a DataLUT entry, and a DirMap entry. The maintained set of data blocks may be updated with the update packet.

In 1406, the updated maintained set of data blocks may be compressed.

In 1407, the updated maintained set of data blocks may be encrypted. In one embodiment, the updated maintained set of data blocks may not be compressed prior to encryption.

In 1409, the encrypted updated maintained set of data blocks may be written. For example, the encrypted updated maintained set of data blocks may be written to a storage medium such as, but not limited to, a hard disk.

FIG. 15 is an embodiment of a flowchart for reorganizing references files. It should be noted that in various embodiments of the methods described below, one or more of the processes described may be performed concurrently, in a different order than shown, or may be omitted entirely. Other additional processes may also be performed as desired.

In 1501, the publisher may determine which sections of the DataLUT file and the DirMap file are not being used. In one embodiment, the client computer system may determine which sections of the DataLUT file and the DirMap file are not being used.

In 1503, instructions may be provided to delete the unused portions from the DataLUT file and the DirMap file. In one embodiment, the publisher may provide instructions for deleting unused portions of the DataLUT file and the DirMap file.

In 1505, pointers in the DataLUT file and the DirMap file that are affected by the deleted unused portions may be updated. For example, pointers in the DataLUT file and the DirMap file may point to data blocks in the maintained set of data blocks.

In 1507, the DataLUT file and the DirMap file may be consolidated. For example, in recursive entries in the DataLUT file and DirMap files, an unneeded entry in a chain of entries (each entry referring to the previous entry) may no longer be used.

In some embodiments, a representation of an arbitrary file system or web documents uses a three-level data structure:
1. The Directory Map (DirMap) is an array, spanning the entire file system, where each entry denotes a file or a directory. Each DirMap entry identifies its parent (as a DirMap entry reference) and has a name. This pair of values is a unique key for the file or directory within the DirMap array and is searchable. For DirMap entries denoting a directory, the children (files and sub-directories) within the directory are arranged as a contiguous range of further DirMap entries, identified as an offset into the entire DirMap array and a count of such children. For DirMap entries denoting a file, the contents of the file are denoted by a contiguous range of DataLUT entries in the Data LookUp Table (DataLUT) structure, identified in the DirMap entry as an offset into the entire DataLUT array and a count of such entries.
2. The Data LookUp Table (DataLUT) is an array where each entry denotes part of the contents of a file. Multiple DataLUT entries may reference the same part of a file, where contents are shared between files. Each DataLUT entry contains its virtual offset within the file to support seeking. The data bytes referenced are identified by a three part value: (1) The number of the data block file in which the required data bytes are stored; (2) The offset within that data block file at which the required data bytes starts; and (3) The length of the array of data bytes denoted by this DataLUT.
3. The actual bytes may be stored in one or more data block files as an unstructured concatenation of the data for each unique DataLUT. Data block files may be created for each amendment, but then not change in subsequent amendments, ensuring that references in all DataLUTs remain valid.

In some embodiments, a client system interprets the structure at the file system driver level, in order to return to arbitrary accessing programs. Virtual content may be constructed from the representation. (Other client mechanisms are possible, for example, to construct and return content via HTTP.)

In some embodiments, a publisher system generates a sequence of amendments (each in this representation), identifying the differences between the data published in the previous amendment and the current contents of the source data being published. Each amendment can update only the DirMap and DataLUT structures and may add one or more new data block files. The updated DataLUT can reference the new data block files or can reference any existing data in any earlier data block files. In this way, each amendment may contain only the data which is newly added since the previous amendment, thus making best use of slow, unreliable or expensive communications channels.

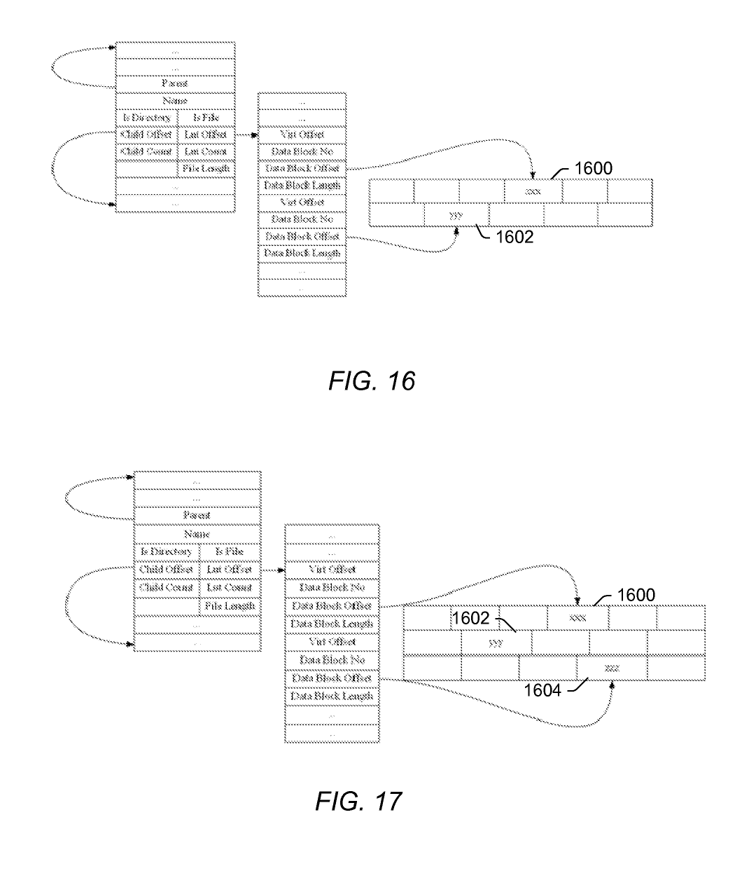

FIG. 16 illustrates an example of a structure for represented content. The represented content contains a file, in which the content “xxxyyy”, where “xxx” and “yyy” had been identified by the publisher as distinct (and possibly shareable) sequences of data bytes. In this example, there are two data block files 1600 and 1602, one of which contains the “xxx” data and another contains the “yyy” data.

FIG. 17 illustrates a modification to the structure for an amendment to the represented content shown in FIG. 16. In this modification, the published contents have been updated to “xxxzzz”, where “zzz” never previously appeared in the entire published content, and “yyy” no longer appears anywhere in the entire published content. A new data block file 1604 has been added to contain “zzz”. The “yyy” remains, currently unreferenced but available to be referenced (if so required) by a future amendment.

In some embodiments, a system implements a compaction mechanism for reducing the storage requirements for a file system. The compaction mechanism includes two independent parts: compression and compaction.

Compression methods and the compaction mechanism, as may be implemented in some embodiments, may be as further described below.

### Compression

Files in the content may be compressible. In some embodiments, files are compressed (for example, losslessly compressed) into reduced storage space and re-constructed when needed. Many common document formats which are not directly compressible (such as Microsoft Office documents or Zip files) may be automatically transformed into a compressible form. Such usage is described, for example, in U.S. Pat. No. 7,028,251, which is incorporated herein by reference as if set fully set forth herein. The sequences of bytes from these files stored in data block may be compressible by other techniques, such as LZW.

Each separate data block file need not necessarily be compressed in its entirety. The pattern of access by the Client when reading virtualized content can read segments from random ranges of bytes within a number of a very large data block files. Such files are often hundreds of megabytes. As such, it may be inefficient to decompress the entire data block file to access only a small portion of it.

In some embodiments, a data block file is compressed using block-wise compression. The uncompressed data block file may be segmented into convenient chunks (for example, 16 kB) and each chunk may be independently compressed. The chunking may be of a fixed size within the data block file, independently of any ranges of bytes in the file addressed by separate DataLUT entries. A single DataLUT entry can address a range that spans two (or more) chunks of stored data.

For arbitrary data, it may be not be possible to determine a priori the size of a resultant compressed chunk block. In some embodiments, a separate chunk index table is constructed to store the offset of the start of the compressed chunk for each of the uncompressed addresses (for example, 16 kB). The DataLUT may continue to use these uncompressed addresses, and does not need to be changed by this compression. Each data block file can be compressed in isolation, with no need to repeatedly update DataLUT entries that reference it.

In order to minimize the size of amendments transferred, block-wise compression may be performed on each client computer independently on receipt of each new amendment. A sequence of separately compressed blocks may be less efficiently compressed than by a whole-file compression which can be used for the complete amendment. Consequently, the communication bandwidth to transfer the amendments is not affected by any use of block-wise compression on the client computers.

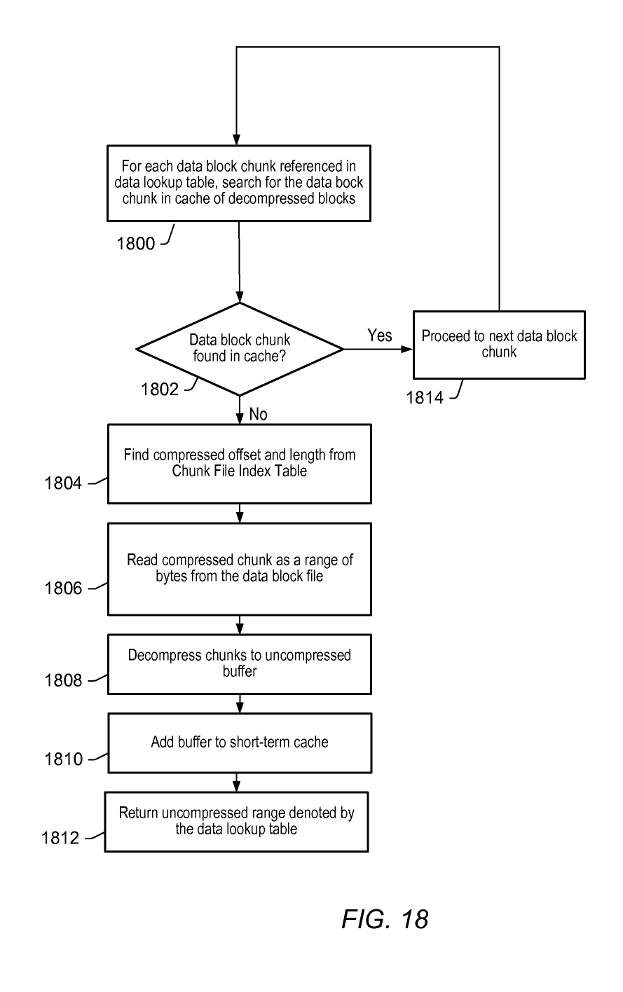

In an embodiment, the client's file system filter driver is used to read all or part of a virtual file. FIG. 18 illustrates one embodiment of a mechanism for reading a file. For each DataLUT in the range to be read, for each separate data block chunk referenced by that DataLUT (data block chunks may be fixed size or variable size), a search is made for the data block chunk in a cache of decompressed blocks at 1800. At 1802, if not found in the cache, the compressed offset and length are found from the Chunk Index Table at 1804. The entire compressed chunk is read as a range of bytes from the data block file at 1806. The chunks may be decompressed into an uncompressed buffer at 1808. The buffer is added to a short-term cache at 1810. The part of that uncompressed range denoted by the DataLUT is returned at 1812.

At 1814, if the data block chunk is found in the cache, the system may proceed to the next data block chunk referenced in the data lookup table.

Compression alone has some benefit. In some cases, for example, the disk space used to represent a publication may in some cases be reduced by over a factor of two.

In some embodiments, compression is performed as an enabling mechanism for compaction (see, for example, as described below).

### Compaction

In some embodiments, a method for increasing data storage efficiency includes compaction of an amended version of set of data objects. Compaction may include identifying unreferenced content and replacing the unreferenced content with more compressible content. Compaction may be performed, for example, for file systems such as described above relative to FIG. 4 through FIG. 15.

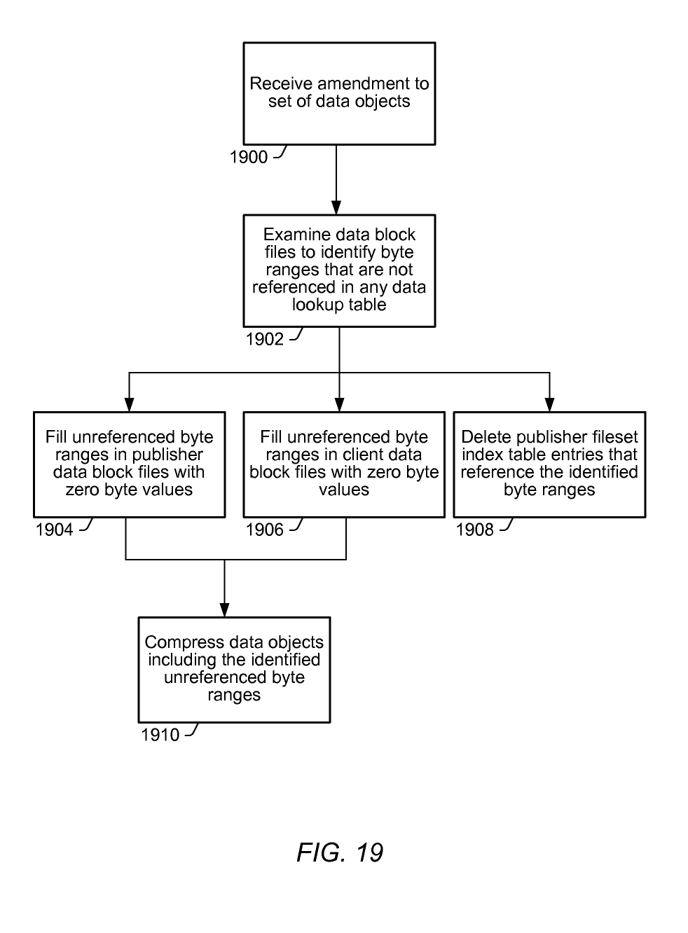

FIG. 19 illustrates one embodiment of increasing data storage efficiency using a compaction mechanism. At 1900, an amendment to a set of data objects is received. The amendment may include new or changed content relative to an earlier version of the set of data objects. The amendment may include one or more data lookup tables, wherein the set of data objects comprises one or more data blocks associated with the one or more data lookup tables. In one embodiment, the amendment is received by a client from a publisher over a network.

At 1902, when the amendment is created on the Publisher or applied on the client, the byte ranges in all the data block files are examined to identify those byte ranges that are not referenced by any DataLUT in the entire DataLUT array. These byte ranges are then data which cannot be used in any virtual file in the current published contents.

For such unwanted byte ranges, the unused byte ranges in the Publisher data block files are all filled with zero byte values at 1904 and the unused byte ranges in the client data block files are set to zero byte values at 1906. In addition, Publisher Fileset Index Table entries referencing the unused byte ranges are deleted at 1908.

Filling the unused byte ranges of the publisher data block files does not reduce the storage space on the publisher, but if these data block files are added to future amendments (such as installer amendments), then those amendments may be compressed to a smaller size than they otherwise would. Sequences of zero bytes may compress extremely well.

Deleting the Publisher Fileset Index Table entries may produce some benefits. First, the size of the (typically large) Fileset Index Table will not grow monotonically, remaining at a size proportional to the total size of the published data. This may allow the table to fit into bounded (and typically limited) RAM in-core computer memory. Second, further amendments will not be able to re-use the byte range, as the further changes would render such future usage incorrect.

At 1910, at least a portion of the set of data objects is compacted. Compacting may include data including at least one of the identified unreferenced data ranges.

In cases where data block files are stored in compressed format, setting the unused byte ranges in the Client data block files to zero byte values may include a multi-step process of decompression/zeroing/recompression. In particular, the process may include decompressing the block currently stored, zeroing the data in the uncompressed block, and then recompressing. This recompression will reduce the storage space required. In some cases, compression of the sequence of the zero bytes is so effective that the net resultant space used is as though the unwanted data byte ranges are totally deleted.

From the standpoint of file system/data integrity, compaction may not always be safe at the time of the application of a compacting amendment. For example, a compressed data block file may be in use by the file system filter driver to access virtual file contents at the time of the compacting amendment. In such cases, compaction may be deferred for later retry. In systems where no other data structures are updated by the compaction, deferral is always a safe option. If there is a need for deferral (e.g., to update currently-in-use data), then that imposes the constraint that no other data structures are updated by the compaction. Using the compaction mechanism described herein, compaction of data blocks may be achieved without any transactionally-safe need to update multiple references to that compacted data.

In some embodiments, compaction is implemented as an option that can be performed when space saving is required. Compaction may be initiated by a user, based on a pre-determined time intervals, or based on pre-determined rules. No data structure needs to be updated beyond each data block file, which can be processed independently (but with its own Chunk Index Table). Consequently, compaction can be implemented to have very localized impact on the file system update mechanism. In some embodiments, compaction is run as an interruptible iterative background process. The compaction process may be resumable at any point, for example, following the restart of the computer program. Safe checkpoints may be established for intermediate states.

For illustrative purposes, in the example described above, the compaction mechanism has been described for a client data bock files. Other types of files and storage structures may, however, in various embodiments, be compacted.

In another embodiment, data is compacted in publisher data block files. In order to re-generate amendment files or to generate installer amendments to efficiently add further client computers to the set of those consuming amendments, the Publisher retains all data block files that have been incorporated into amendments. These files may or may not be held in compressed form, since disk space may not be an issue for the Publisher.

In some embodiments, specific amendments are designated as compacting amendments. In one embodiment, compacting amendments are designated by user choice.

In some embodiments, a system may be configured to not automatically compact every amendment. There are several reasons that a system might not automatically compact every amendment. First, the mechanism described below is relatively expensive and all the benefits of compaction may accrue from occasional use of the mechanism—thus, it may not be necessary every time. Second, there are patterns of usage where compaction can cause subsequent amendments to be larger than they otherwise would be. In the data structure described above relative to FIGS. 16 and 17, for example, this would occur if some later amendment contained the “yyy” content. In such case, it would have been a benefit not to compact. Third, there may be occasions where compaction is not required. For example, in a particular case, storage space so inexpensive that it is not worth reclaiming.

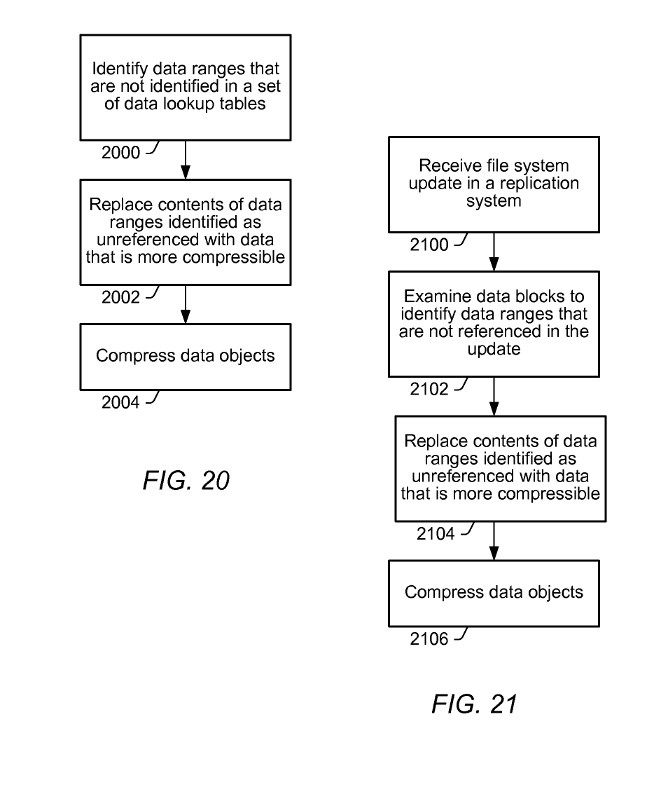

FIG. 20 illustrates a method for increasing data storage efficiency that includes replacing data that is unreferenced a data lookup table with more compressible data. The data objects include data blocks associated with a set of data lookup tables.

At 2000, data ranges that are not referenced in the set of data lookup tables are identified. Data ranges may be identifying by scanning the data objects and mapping data blocks to generate a region map. Mapping may include finding pointers to a region or location one or more of the data objects.

In some embodiments, unreferenced ranges are by inference from referenced regions or locations of a file. For example, if a full scan of a file including sequential regions A-H identifies pointers to sequential ranges A, B, D, G, and H, the system may infer that regions C, E, and F are unreferenced. In some embodiments, a file is decompressed before scanning to determine the unreferenced regions. The file may be re-compressed after scanning.

At 2002, the data ranges identified as unreferenced are replaced with data that is more compressible. For example, the content of the unreferenced data ranges may be replaced with null (e.g., zero) values.

At 2004, the set of data objects is compressed. Compression may be performed using any suitable method of compression, such as the methods described herein.

In some embodiments, compaction is performed on the set of data objects for a predetermined compaction window. In some embodiments, the compaction window may be based on a specific period of time. For example, compaction may be performed for data that has not been referenced in the preceding 3 days, the preceding 12 hours, or other suitable time period. In some embodiments, the window can be set by a user (for example, via a graphical user interface).

In some embodiments, compaction is performed on the set of data objects based on a set of rules. In some embodiments, compaction may be carried out for content that has not been referenced in the preceding N amendments (for example, the last amendment, or the last three amendments). In some embodiments, rules on whether to compact or not are based on system parameters, such as current storage capacity.

In some embodiments, a method for increasing data storage efficiency in a replication system includes identifying content in a file that is not referenced in a file system update, and replacing it with more compressible content. FIG. 21 illustrates one embodiment of increasing storage efficiency in a replication system. At 2100, an update is received to a file system. In some embodiments, the update is received to a client computer of the replication system from a publisher computer of the replication system. The file system may include a set of data objects. Each data object may include data blocks. The update may be received over a network. In some embodiments, a network connection is available only on an intermittent basis.

At 2102, the data blocks are examined (for example, scanned) to identify data ranges that are not referenced in the update. Unreferenced data ranges may be identified, in some embodiments, by scanning data objects for references to data ranges by data lookup tables, such as described above relative to FIGS. 19 and 20.

At 2104, the contents of the data ranges that have been identified as having unreferenced content are replaced with data that is more compressible. The data may be replaced, for example, with zero values.

At 2106, the set of data objects is compressed. Compression may be performed using any suitable method of compression, such as the methods described herein.

In some embodiments, compacting amendments are applied in a replication system based on rules. The rules for making applying compacting amendments may be based, for example, on available storage capacity, time window, age of amendment, or combinations thereof.

Various embodiments may further include receiving or storing instructions and/or information implemented in accordance with the foregoing description upon a carrier medium. Suitable carrier media may include storage media or memory media such as magnetic or optical media, e.g., disk or CD-ROM, as well as transmission media or signals such as electrical, electromagnetic, or digital signals, conveyed via a communication medium such as a network and/or a wireless link

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A method for increasing data storage efficiency, comprising:
receiving an amendment to a set of data objects, wherein the amendment comprises new or changed content relative to an earlier version of the set of data objects, wherein the amendment comprises one or more data lookup tables, wherein the set of data objects comprises one or more data blocks associated with the one or more data lookup tables;
examining the set of data objects,
wherein examining the set of data objects comprises identifying, in the one or more data blocks, one or more data ranges that are not referenced in the set of data lookup tables of the amendment; and
replacing, in at least one of the identified data ranges that is not referenced in the data lookup tables, data in the identified data range with data that is more compressible; and
compacting at least a portion of the set of data objects, wherein compacting the at least a portion of the set of data objects comprises compressing data including at least one of the identified unreferenced data ranges.

2. The method of claim 1, wherein replacing the data in at least one of the identified data ranges comprises replacing the data with null values.

3. The method of claim 1, wherein compaction is performed on the set of data objects for a predetermined compaction window.

4. The method of claim 3, wherein the predetermined compaction window is a period of time prior to the compaction.

5. The method of claim 1, further comprising, determining whether to perform a compacting operation to increase data storage efficiency based on one or more rules.

6. The method of claim 1, wherein the amendment is received to a client of a replication system from a publisher of the replication system.

7. A system, comprising:
a processor;
a memory coupled to the processor, wherein the memory comprises program instructions executable by the processor to implement:
receiving an amendment to a set of data objects, wherein the amendment comprises new or changed content relative to an earlier version of the set of data objects, wherein the amendment comprises one or more data lookup tables, wherein the set of data objects comprises one or more data blocks associated with the one or more data lookup tables;
examining the set of data objects,
wherein examining the set of data objects comprises identifying, in the one or more data blocks, one or more data ranges that are not referenced in the set of data lookup tables of the amendment; and
replacing, in at least one of the identified data ranges that is not referenced in the data lookup tables, data in the identified data range with data that is more compressible; and
compacting at least a portion of the set of data objects, wherein compacting the at least a portion of the set of data objects comprises compressing data including at least one of the identified unreferenced data ranges.

8. (canceled)

9. A method for increasing data storage efficiency, comprising:
examining a set of data objects, wherein the data objects comprise one or more data blocks associated with a set of one or more data lookup tables,
wherein examining the set of data objects comprises identifying, in the one or more data blocks, one or more data ranges that are not referenced in the set of data lookup tables; and
replacing, in at least one of the identified data ranges unreferenced by the data lookup tables, the data in the identified data range with data that is more compressible.

10. The method of claim 9, wherein the update is an amendment to an earlier version of the set of data objects.

11. The method of claim 0, wherein replacing the data in at least one of the identified data ranges comprises replacing the data with null values.

12. The method of claim 9, wherein replacing the data in at least one of the identified data ranges comprises replacing the data with zeroes.

13. The method of claim 9, further comprising compacting at least a portion of the set of data objects.

14. The method of claim 9, wherein compacting of the data objects is interruptible and restartable.

15. The method of claim 9, wherein compacting the data comprises:
compressing at least a portion of the data objects, wherein the compressed portion of the data objects at least one of data ranges in which the contents have been replaced by more compressible data.

16. The method of claim 9, wherein compaction is performed on the set of data objects together with the set of data lookup tables created within a predetermined compaction window.

17. The method of claim 16, wherein the predetermined compaction window is a period of time prior to the compaction.

18. The method of claim 9, further comprising, determining whether to perform a compacting operation to increase data storage efficiency based on one or more rules.

19. The method of claim 9, wherein compaction is performed based on user-specified criteria.

20. The method of claim 9, wherein the update is received to a client of a replication system from a publisher of the replication system.

21. (canceled)

22. The method of claim 9, wherein the update is received to publisher in a replication system.

23-43. (canceled)
